(19) United States
(12) Patent Application Publication
(10) Pub. No.: US 2025/0324251 A1
(43) Pub. Date: Oct. 16, 2025

(54) ACCESS SYSTEM, SYSTEM TO FACILITATE TRANSACTION BETWEEN BATTERY-LESS CREDENTIAL DEVICE AND SERVICE PROVIDER SYSTEM, AND CREDENTIAL CARD

(71) Applicant: Christopher John Burke, Yau Tong (HK)

(72) Inventor: Christopher John Burke, Yau Tong (HK)

(21) Appl. No.: 19/171,777

(22) Filed: Apr. 7, 2025

(30) Foreign Application Priority Data
Apr. 15, 2024 (HK) 32024090105.0

(51) Int. Cl. H04W 12/06; H04W 12/47; H04W 12/50

(52) U.S. Cl. CPC H04W 12/06; H04W 12/47; H04W 12/50

(57) ABSTRACT

A system to facilitate a transaction between a credential device and a service provider system. The credential device is configured for bi-directional wireless communication with a credential device reader. The credential device reader is wirelessly connected to a controller by a bi-directional wireless communications link. The controller is in communication with the service provider system and arranged to convert credential data received from the credential device via the reader device encapsulated in a wireless communications protocol to a different communications protocol of a communications link between the controller and the service provider system.

### TECHNICAL FIELD

The present disclosure relates to an access system, a system to facilitate a transaction between a battery-less credential device and a service provider system, and a credential card.

### BACKGROUND

Traditional access systems are mostly based on one-way communication technologies, such as Near Field Communication (NFC) or magnetic stripe technology. These systems rely on static identifiers (IDs) for authentication, posing security risks of data being easily stolen or replicated. For example, existing NFC credential devices need to be powered by induction from a card reader at a close distance (usually less than 10 centimeters) to transmit unencrypted plaintext IDs, enabling attackers to illegally obtain access rights through relay or cloning techniques. In addition, the wired access control system based on the Wiegand protocol, although widely used in access control management, relies on physical cables to transmit unencrypted data. It has a high deployment cost and is difficult to expand, making it hard to be compatible with the Internet of Things (IoT) or modern network architectures.

### SUMMARY

The present disclosure provides an access system, a system to facilitate a transaction between a battery-less credential device and a service provider system, and a credential card.

In a first aspect, the present disclosure provides a security access system. The access system includes: a battery-less credential device configured to receive power via wireless power or magnetic induction; a credential device reader configured to wirelessly provide power to the battery-less credential device using a Qi2 standard and to bi-directionally communicate with the battery-less credential device via a Bluetooth Low Energy (BLE) or Internet of Things (IoT) protocol; a controller wirelessly connected to the credential device reader and configured to convert credential data received in a wireless protocol to a secondary protocol, such as Wiegand-compatible clear-text protocol; and a security access validation system in communication with the controller via a wired or wireless link, the security access validation system configured to validate the credential data and transmit a Wiegand-compatible response to the controller; where the controller converts the Wiegand-compatible response to the wireless protocol and transmits it to at least one of the credential device reader, the battery-less credential device, or a third-party device.

In a second aspect, the present disclosure provides a system to facilitate a transaction between a battery-less credential device and a service provider system. The system to facilitate the transaction between the battery-less credential device and the service provider system includes: the battery-less credential device configured to receive power via magnetic induction from a credential device reader or an associated device; the credential device reader configured to wirelessly communicate with the battery-less credential device using a Bluetooth Low Energy (BLE) or Internet of Things (IoT) protocol; a controller wirelessly connected to the credential device reader and configured to convert credential data from the wireless protocol to a protocol compatible with the service provider system; and the service provider system configured to process the credential data and transmit response data to the controller; where the controller initiates an action or transmits the response data to at least one of the credential device reader, the battery-less credential device, or a third-party device.

In a third aspect, the present disclosure provides a credential card. The credential card includes: a processing module; a memory module storing machine-readable instructions executable by the processing module; a Qi2-compatible electromagnetic induction module configured to scavenge power from an external source to provide power to the processing module; a wireless communication module supporting at least one of Bluetooth Low Energy (BLE), Near Field Communication (NFC), or Internet of Things (IoT) protocols; a security module encrypting data transmitted via the wireless communication module; and an optional display, such as an E-INK display configured to display at least one of user identity data, biometric data, or transaction-related information.

### BRIEF DESCRIPTION OF THE DRAWINGS

The foregoing and further features of the present disclosure will be apparent from the following description of preferred embodiments which are provided by way of example only in connection with the accompanying figures, of which:

FIG. 1 is a schematic diagram of a system in accordance with the present disclosure;

FIG. 2 is a schematic diagram of a known security access system;

FIG. 3 shows three reader output scenarios (A, B, C); and

FIG. 4 is a circuit diagram of a Wiegand access system showing the 2 wire Wiegand data link.

### DETAILED DESCRIPTION

The following description is of preferred embodiments by way of example only and without limitation to the combination of features necessary for carrying the present disclosure into effect.

Reference in this specification to “one embodiment” or “an embodiment” means that a particular feature, structure, or characteristic described in connection with the embodiment is included in at least one embodiment of the present disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the figures may be implemented in various forms of hardware, software, or combinations thereof. These elements may be implemented in a combination of hardware and software on one or more appropriately programmed general-purpose devices, which may include a processor, memory, and input/output interfaces.

The present description illustrates the principles of the present disclosure. It will thus be appreciated that those skilled in the art will be able to devise various arrangements that, although not explicitly described or shown herein, embody the principles of the present disclosure and are included within its spirit and scope.

Moreover, all statements herein reciting principles, aspects, and embodiments of the present disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams presented herein represent conceptual views of systems or devices embodying the principles of the present disclosure.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode, or the like, combined with appropriate circuitry for executing that software to perform the function. The present disclosure as defined by such claims resides in the fact that the functionalities provided by the various recited means are combined and brought together in the manner which the claims call for. It is thus regarded that any means that can provide those functionalities are equivalent to those shown herein.

The credential device may include a battery-less device. The credential device may be configured to receive power by magnetic induction from a credential device reader or an associated device. The credential device may have a rechargeable battery power supply and be configured to recharge the battery by the Qi magnetic indication power standard using any of a charging device, the credential device reader or the associated device. The associated device may include a smart phone, tablet computer, or the like paired with the credential device. The credential device is also configured for bi-directional wireless communication with the credential device reader. The credential device reader is wirelessly connected to a controller by a bi-directional wireless communications link. The controller is in communication with the service provider system and arranged to convert credential data received from the credential device via the reader device encapsulated in a wireless communications protocol to a different communications protocol of a communications link between the controller and the service provider system.

Preferably, the credential device reader is configured to provide power to nearby devices using the Qi2 standard. The credential device reader is preferably configured with the Bluetooth Low Energy (BLE) standard, and the Internet of Things (IoT) communications protocol. Preferably also, the credential device reader has one or more of: a camera, an E-INK display, a USB functionality including a USB power input connector, and be Wi-Fi enabled. The credential device reader may also have other means for users to input biometric data. The credential device reader preferably has a rechargeable battery power supply. The credential device preferably includes a card or ISO card-sized device. The credential device is enabled with BLE functionality and Near Field Communication (NFC) functionality. The credential device is preferably a non-contact device. The credential device may have a battery power source chargeable by a Qi2 device. It may also have one or more supercapacitors for immediate power draw and for short-time power storage.

The present disclosure relates to a system 10 to facilitate a transaction between a battery-less credential device 12 and a service provider system 14. The system 10 includes the battery-less credential device 12, a credential device reader 16, a controller 18 controlling access to the service provider system 14, and the service provider system 14. The battery-less credential device 12 is configured to receive power by magnetic induction from the credential device reader 16 or a device 20 associated with the credential device 12. The associated device 20 may include a smart phone, a tablet computer, or a similar electronic data processing device. The credential device 12 may be associated with the associated device 20 by means of pairing the credential device 12 with the associated device 20 or by any suitable means. In one embodiment, the credential device 12 may be configured to interoperate with an application hosted by the associated device 20.

Preferably, the credential device 12 is configured to operate the Qi™ wireless power transfer standard. More particularly, the credential device 12 is preferably configured to operate the Qi2™ wireless power transfer standard. This has the advantage of providing up to 15 Watts of power to power the credential device's IC chip 22 to implement the applications and/or algorithms embodied in the IC chip 22 for implementing aspects of the present disclosure and encrypting data directly on the credential device 12. The credential device 12 is also configured for bi-directional wireless communication with the credential device reader 16 to provide credential data to the credential device reader 16 and to receive response data or other data from the credential device reader 16, from the controller 18, and/or from other wireless devices and/or systems collectively denoted by numeral 24.

The credential device reader 16 is wirelessly connected to the controller 18 and configured for bi-directional wireless communication with the controller 18 to provide received credential data to the controller 18 and to receive response data and/or other data from the controller 18 and/or the other devices or systems 24.

The controller 18 is arranged to be in communication with the service provider system 14 and, in some embodiments, acts as a gateway to the service provider system 14. A communications link 26 between the controller 18 and the service provider system 14 may include a wireless bi-directional communications link 26A or a wired communications link 26B. In either case, the communications protocol used between the controller 18 and the service provider system 14 is different to the one or more wireless bi-directionals protocols implemented between the credential device reader 16 and the controller 18 and/or between the credential card 12 and the credential device reader 16. As such, the controller 18 is arranged to convert the received credential data encapsulated in one of the bi-directional wireless communications protocols to the different communications protocol of the communications link 26. At least the communications link 26 between the controller 18 and the service provider system 14 includes a secure communications link preferably involving encryption of transmitted and received data, but preferably further all of the communications links 26, 28, 30 between the credential device 12 and the service provider system 14 include a secure communications channel for security of transmitted and received data between the various devices/systems 12, 14, 16, 18 including the system 10.

The service provider system 14 is arranged to process the received credential data and, dependent on the purpose or application associated with the transmission of the credential data from the credential device 12 to the service provider system 14, to provide response data to the controller 18. The controller 18, on receiving the response data, initiates an action and/or conveys the response data to any one or more of the credential device readers 16, the credential device 12, a device or facility 32 associated with the credential device reader 16, the device 20 associated with the credential card 12, and/or a third party device or system to initiate an action as will be more fully explained hereinafter.

In one embodiment, the credential device 12 may include a battery-less credential card compliant with the International Organization for Standardization (ISO) specification for credit cards, debit cards, or the like and, more particularly, compliant with ISO standard ISO8583, but modified in accordance with aspects of the present disclosure.

In one embodiment, the credential card 12 may have a smart phone, a tablet computer, or similar electronic data processing device 20 associated with it as will be explained hereinafter.

In one embodiment, the smart phone, the tablet computer, or the similar electronic data processing device 20 may include or replace the credential card reader 16.

In one embodiment, the service provider system 14 may include a security access system. The security access system 14 may include a security access system for controlling entry of authorized persons to a secure or controlled premises such as, for example, any of an office, a factory, a military installation, or the like. Consequently, in this embodiment, the transaction being facilitated between the credential device 12 and the security access system 14 is an access permission transaction and the response data issued by the security access system may include a denial of permission or a granting of permission for the requested security access, or data related thereto, to initiate or prevent the requested security access.

The communications link 26 between the controller 18 and the security access system 14 may include a two or three-wire communications link 26B preferably based on the Wiegand interface or Wiegand communications protocol. As such, the controller 18 is arranged to convert data communicated to the controller 18 over the one or more bi-directional wireless communications links 28, 30 from the one or more bi-directional wireless communication protocols to the Wiegand communications protocol and vice-versa. This has the advantage that the wired connection 26B required in a Wiegand protocol based security access system does not need to extend to the credential device reader 16 and/or to an asset such as, for example, an entrance door 32 controlled in connection with a co-located credential device reader 16. The controller 18 can be located close to an access control computer system or device 34 of the security access system 14, the access control computer system or device 34 being configured to implement one or more security access protocols of the security access system 14.

There may be provided one or more controllers 18 in the security access system 14 located as close as practicable to the access control computer system or device 24.

In one embodiment, the security access system 14 may include a security access system 14 for controlling access to electronic data processing devices or systems.

In one embodiment, the service provider system 14 may include a financial transaction system such as, for example, a bank service, a credit card service, a ticketing service, or the like. In this embodiment, the preferred communications protocol for the communication link 26 between the controller 18 and the service provider system 14 includes the Transmission Control Protocol/Internet Protocol (TCP/IP). In this embodiment, the controller 18 is arranged to convert data communicated to the controller 18 over the one or more bi-directional wireless communications links 26, 28 from the one or more bi-directional wireless communication protocols to TCP/IP and vice-versa.

Preferably, the credential device 12 is configured to wirelessly communicate bi-directionally with the credential device reader 16 using the Internet of Things (IoT) communications protocol and/or the Bluetooth™ communications protocol or the Bluetooth Low Energy (BLE) communications protocol. The credential device 12 may also be configured to implement near-field communication (NFC) in addition to one or more of the other wireless communications protocols.

Preferably also, the credential device reader 16 is configured to wirelessly communicate bi-directionally with the controller 18 using the IoT communications protocol.

It will be understood that the credential device 12 will have assigned to it a unique identifier. The unique identifier is preferably associated with a user of the credential device 12 by associating the unique identifier with credential data of said user. The credential data of the user may include, for example, any one or more of a username, a password, identification data such as a passport number or an identification card number, an employee number, a credit card number, a bank account number, a house number, biometric data, or the like. The user's credential data is preferably securely stored in the credential device 12 through encryption or any other suitable security mechanism. The unique identifier of the credential device 12 may be employed with any of the user's credential data to implement a one-time password (OTP) or similar scheme for enabling the user to securely access the service provider system 14. Two factor authentication (TFA) of the user may be implemented using, for example, an application such as the Google Authenticator™ upon the input to the credential device 12 of a user password or a biometric input from the user.

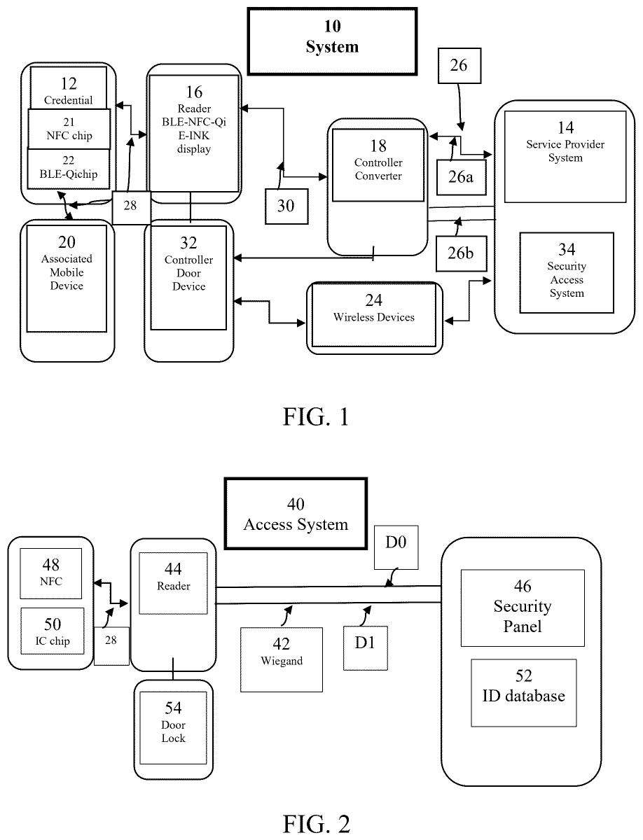

Reference is now made to FIG. 2 which schematically illustrates an existing security access system or access control system 40. Many existing access control systems such as system 40 rely mainly on physical wires 42 for connection and communication between a Wiegand-compatible reader device 44 and a Wiegand-compatible security panel 46. The data transmissions between the reader device 44 and the security panel 46 are normally in clear-text, unencrypted format. Typically, an NFC enabled access card 48, fob, or the like is badged to the reader device 44, whereby the access card 48, when close to the reader device 44, scavenges sufficient power from the reader device 44 to power its NFC chip 50 to thereby transmit an assigned identification (ID) number to the reader device 44 that may be unique, or at least unique to the security panel 46. The security panel 46 receives the ID number via the Wiegand protocol over the wired connection 42. The security panel 46 then determines if the access card 48 has rights to the requested entry location. The security panel typically uses an ID database 52 with applicable stored rights to entry, often based on location and time etc., to validate or decline the received ID number, i.e., to validate or decline the entry request. If the received ID number is validated by the security panel 46, the security panel 46 sends a Wiegand-compatible signal over the wired connection 42 to a device 54 typically co-located with the device reader 44 to initiate an access action such as, for example, causing a door to open. The device 54 typically includes a solenoid-actuated door lock or the like.

It is noted that user access rights are linked to the card 48 and not linked directly to an identity of a person holding the card 48. It is therefore possible for an unauthorized person using a stolen or misplaced card 48 to gain access to a facility. This risk is often mitigated by having a photograph of the authorized person placed on the card 48, but photograph checks are often not performed or performed with low accuracy.

Furthermore, the access control system 40 described above has other significant limitations relating to the expandability of the system 40, but expanding such systems 40 with their wired Wiegand links 42 is costly and physically and it is not easy to link such systems 40 to logical PC networks, communications, system, the internet, etc.

Referring again to FIG. 1, one aspect of the present disclosure is to provide an access system 14 which is expandable and secure, offers seamless integration with communications networks, has expandable connectivity, and exhibits a much lower cost of installation and implementation than, for example, existing systems 40 as shown in FIG. 2.

As already described, controller 18 converts IoT or radio frequency (RF) transmissions into applicable Wiegand protocol or commensurate protocol signals, i.e., into clear-text Wiegand data. In addition to negating the need for the wired communication link 26B to extend to the credential card reader 16, a further advantage is that the installation of the controller 18 to the security access system provides a seamless connection of the security access system to communications networks without any significant physical changes to an existing security access system such as that shown in FIG. 2.

In the case where the wired connection 42 (FIG. 2) remains installed even after installation of the controller 18 (FIG. 1) and the security access system 14 validates the card 12, the security access system 14 sends a clear-text Wiegand response signal to the controller 18 and the controller 18 conveys a DC voltage signal over the existing wired connection 42 to the door control unit 32, thereby releasing the holding electrical force on the door lock and enabling access through the door.

Preferably, however, the controller 18 accepts the clear-text Wiegand response signal as the verification for the card entry and then generates an RF or IoT wireless signal back to the door control unit (or any other IoT enabled device), thereby removing the need for the wired link 42. This has an advantage of creating a secure wireless network that transforms the security access system 14. The use of IoT to provide a secure wireless network enables additional applications to be implemented within the security access system 14 without requiring physical changes or at least without requiring significant physical changes to an existing security access system.

A smart credential can be considered as a piece of information and/or evidence that confirms a person's identity, qualifications, skills, or authority in a particular field or domain. It is used to verify and authenticate an individual's identity and their eligibility for certain privileges, rights, or positions. Existing credentials can take various forms, such as plastic cards, certificates, licenses, degrees, professional memberships, or other official documents. They are important in establishing trust, demonstrating expertise, and ensuring compliance with specific requirements or standards.

Smart credential devices such as the credential device/card 12, the credential device reader 14, and the controller 18 may be enabled with BLE, NFC, USB, IR, IoT RF, magnetic stripe, QR images, IC Chip, magnetic inductive communication architectures, cameras, touch screens, temperature sensors, human health sensors, E-INK or commensurate dynamic displays, speaker or buzzer, microphone, control knobs, pushbuttons or any other interfaces and controls, plus at least one manufacturer's unique ID. The credential device reader may be wall or desktop mounted to perform a variety of tasks in a more static environment. The controller may, in effect, include communications protocol converters that back-end existing security or financial interfaces and enable IoT and other network platforms to interoperate autonomously.

The ability to communicate to the customer's security system and receive feedback on the access success (via the DC voltage signal) creates a fully wireless solution and integrates the security access system 14 with a wider IoT networked solution. Therefore, cameras can be activated on success or denial of entry, alarms can be initiated for any manner of reasons. The ability to integrate a fully wireless solution into a previously wired system with real-time messaging allows a plethora of further actions or integrations as desired by the system operator.

The controller 18 may be used as the main hub or protocol converter between the IoT devices 12, 16, 20, 24 and the security access system 14. The controller 18 operates as a controller interface and preferably has TCP/IP connections to one or more remote security systems. This may include using artificial intelligence (AI) utilise the IoT network in a far more productive, intelligent and multi-purpose manner.

One such modification of the above technology's more effective integration and determination of authenticity of the user ID is by combining each technology for improved performance. For instance, the credential device reader 16 could have a switch or logical gate open/close mechanism that first needs more inputs to be satisfied, prior to sending the required data to the controller onto the security access system 14 for determination of an access request.

The credential device reader 16 may monitor for the credential device's unique ID much sooner than can be achieved through the credential device's NFC signal, because of the significantly enhanced operating range of IoT. The credential device 12 may be loaded with the same user ID as the NFC ID. Therefore, the credential device reader 16 could first read the credential device 12 IoT ID and then wait for the NFC to be badged to the credential device reader 16 enabling the credential device reader 16 to cross-check both ID's to determine if they are identical. If they are determined to be identical, the credential device reader 16 would then send the appropriate credential data to the controller 18. However, if they are not determined to be identical, the credential device reader 16 may then refuse further communication with the credential device, at least for a pre-determined period of time. Once both IDs match, the access ID (credential data) is then sent to the security access system 14 for entry determination. This modified aspect of the present disclosure could also use Bluetooth or BLE as another communication protocol, with or without IoT. The initial cross-check of stored IDs for IoT/Bluetooth/BLE with NFC provides more certainty that the credential device 12 is authentic, because it is complex to program multiple technology IDs into a credential device 12. Also, IoT and Bluetooth both require more complex encryption algorithms to communicate.

A further modification of the above reading the IoT ID of the credential device 12 much earlier, prior to entry, to upload biometric data such as, for example, a digital image, or fingerprint image, or the like which could be used as a one-to-one authentication of the user at the entry point. The entry point credential device reader 16 may have a camera, fingerprint module, with NFC and display medium. The credential device user approaches the credential card reader 16 and badges their NFC, whereby the credential device reader 16 cross-checks the IoT ID, plus compares the digital image with the real time user image captured by a camera of the credential device reader 16. This modification offers extremely high certainty of the identity of the user prior to access or entry. This modification requires the credential device reader 16 and the credential device 12 to be enabled with the appropriate functionalities, but with no significant changes to the security access system's operation.

Therefore, various outcomes are available by combining different technologies and architectures, with significant improvements in security, and with additional options including, but not limited to; transmitting advertising, logos or notifications to the credential device 12 and/or to the credential device reader 16 by secure IoT or Bluetooth, simultaneously or prior to access determination. This integrated and versatile scenario creates extremely important information awareness by the user, due to their natural focus at the point of entry. Advertising, marketing, lunch specials, OTP, schedules, or important corporate information can be very effectively communicated to the user at the point of entry.

Passwords can be replaced by OTP, and sent to the credential device 12, offering a more comprehensive security scenario combing physical and logical access, including to the building and all associated or permitted computer networks. Static passwords may also be used and modified upon each entry in a known manner. The security access system 14 now has more certainty of both the individual in the building and who is accessing main files or data on the associated or permitted computer network.

AI integration with the controller 18 allows the communicated IoT information to be propagated and disseminated on behalf of the corporate or security system manager/owner. The controller 18 performs a more pivotal role in the security ecosystem and uses integrated or Cloud AI services for information dissemination, encryption, checking and protocol conversion. The controller 18 can operate with the associated or permitted computer networks in any number of ways but is generally connected to the security system via Wiegand protocol, avoiding any significant physical changes to the existing security infrastructure.

The controller 18 can also change IoT displays and functions over the IoT network, possibly configuring the credential device reader 18, or credential device readers 18 where more than one is provided, for different functions, displays or entry requirements. The changes could be based on time-of-day or modified for different locations within the building or for entirely different use cases.

The IoT or Bluetooth credential device reader 16 is preferably installed near the access entry point, with a display, camera, speaker, microphone, doorbell, biometrics option and NFC. This scenario allows for NFC ID combined with biometrics identification prior to entry. When used completely wirelessly, there is an option for an IoT connected door solenoid device for opening or locking. Additional devices could be connected, including garage, burglar system, gates, or other internal displays. IoT tracking of valuable devices can also be connected to determine location and prevent theft.

IoT is a secure versatile network of devices with nodes that can be seamlessly added or removed without interference to normal operation. Thousands of devices can be added for varied purposes.

Another modification of the security access system 14 is the ability to combine technologies for different purposes and at different times. Generally, access control situations occur early morning and later afternoon. Therefore, it is feasible to configure the IoT devices for different functions, especially when they are mostly idle, outside of busy daytime entry and exit hours.

Corporate or retailer operators could send IoT messages, sales promotions etc. to all devices within range, this creates a real-time marketing opportunity, without third party restrictions. The IoT credential devices 12 could be member cards, cashcards, digital wallets or credit/debit cards. This could be very effective in a controlled area, clubs, work venues, malls, airports, government premises etc. Military applications could utilise temperature checking to determine health, plus IoT signal strength for direction or location. Defined and coordinated operating environments enable each user IoT ID device to interrogate their collective communications for greater detail and management. Military ship crews, airport staff and travellers, conference attendees, etc., would be able to communicate, and determine many parameters, including health, location, information, status etc. AI-powered systems could consolidate this information for greater dissemination and decision making, based on overall pre-set customer requirements. Messaging could also be included by voice or touch inputs. This scenario requires no third-party involvement, no IP Address data network whatsoever, and operates over long distances, in the order of kilometers, purely by secure radio frequency RF over IoT networking. In such cases, the power scavenging by the credential device 12 would be from the associated device 20.

Furthermore, the camera in the credential device reader 16 could be used for people tracking, identification, counting, plus movement patterns. The ability to utilise cameras with IoT creates multi-use options, either in light or dark areas, day, or night. When the credential device reader 16 is mounted on a non-secure side of the entry point, the camera could check that one individual entered after using their credential, therefore it could determine if more than one person entered and reduce multiple people entering at the same time (reduce people tail-gating). This is especially useful in large construction sites when users badge in multiple workers or where one person allows multiple people to enter without identification. An alarm is raised, and the photo evidence is available for later reference.

The credential device reader 16 could also utilise the camera to operate in a retailer's premises for both security access and people counting, plus people movement patterns. The retailer could also tag items to guard against theft. The IoT network devices could detect a customer unlawfully taking a product outside the premises or controlled environment. Movement patterns could quickly determine if customers walked past or avoided stopping at the cash register.

Therefore, IoT integration fundamentally changes the landscape of security and creates a plethora of additional user and operator options. AI integration adds another level of capability and programmed operating conditions for the user credential device 12 or the credential device readers 16.

The controller 18 operating as a communications signal protocol converter, would significantly benefit from AI support. IoT device configurations, displays, etc. that are based on user requirements or time of day could be automatically implemented.

In one embodiment, the controller 18 may be combined into one device with the credential device reader 16. In this configuration the solution becomes mobile and can be used in any location or in multiple locations. The combined controller/reader 16/18 offers enormous advantages and flexibility for many different industries.

The combined controller/reader 16/18 with relay outputs offers direct control and power to nearby devices. The Wiegand output offers connections to third-party global security systems. The ability to accept multiple input communications, plus controlling an IoT network, improves the plethora of applications already described. Internal secure storage allows audit trail, storage for passwords, images, banking, personal health records and miscellaneous information. The combined controller/reader 16/18 is less susceptible to malware attacks, in contrast to smartphones and computers. The combined controller/reader 16/18 with AI is a new iteration reader/controller and transitions older unidirectional communication devices into a ‘next generation’ network controller, and versatile security management platform.

The combined controller/reader 16/18 transitions an IP based distributive processing network into a secure managed IoT network and combines both physical and logical access. The ability to control access is a vital step in limiting the success of external attacks, especially when combined with an AI-portal that further ensures compliance to network rules and restrictions. These features and capabilities are the necessary responses required to combat the increasingly aggressive AI malware threats.

Additionally, a credential device reader 16 with IoT can determine user credentials communicating with IoT at long distances. Therefore, tracking the path of users with IoT devices or credential devices 12 can ascertain if they are moving towards a credential device reader 16 well in advance. Steps can be taken to determine if a user is moving towards a given point and early recognition or access rights can be prepared in advance. Once a user is pre-determined, pre-qualified or identified in advance, certain actions can be taken. For instance, facial or biometrics recognition, checking if there are any messages and displaying them on the credential device reader 16, plus if there is any specific profile data and marketing information that can be displayed or utilised in a personal way. Specific user marketing, advertising, and messaging can be accommodated by IoT or similar networks to speed up recognition and incorporate other added-value services.

NFC has a static unidirectional communication transmission, like Magnetic Stripe, Wiegand and other older technology protocols. NFC data may be encrypted and memory spread, however there is no simple ability to respond and create a bidirectional session. In most applications today, clear text data or encrypted data is transmitted to a reader and the information is then forwarded to a central computer for dissemination. Therefore, in nearly all cases involving NFC or unidirectional communications, the credentials have zero determination of the user, due to limitations of the communications and reliance upon a centralised remote controlling system.

NFC devices also become complicated by the variations of suppliers and therefore contain differences in transmission frequencies and operating architectures. NFC may have several unique characteristics, depending on the manufacturer or supplier. Two frequencies are common, 125 KHz and 13.56 MHz, however there are many more variations as manufacturers attempt to differentiate their unique technologies or systems.

Transitioning NFC, Magnetic Stripe, and IC Cards to Bluetooth or IoT significantly expands the technological capability and inherent security. Upgrading from unidirectional to bidirectional communications and enabling decentralised mobile device interoperability affords considerable security and flexibility. Billions of credentials operate globally with minimal security; therefore, there is a need for a seamless transition at low cost.

Transition of any system architecture requires adopting a middleman device to access unidirectional data and convert said data into a bidirectional network topology. Thereafter, new diverse operational devices coexist seamlessly. Bluetooth and IoT are already ubiquitous communication technologies due to their global adoption, but in fact could be any technology that affords bidirectional communications.

One such transitionary device is the controller 18, which converts any structured RF transmission into Wiegand or any required like protocol. The controller 18 interfaces to existing RF certification requirements for universal connectivity conformance. The transition from unidirectional to bidirectional communications can be processed faster by storing a database of user credential IDs internally. This option offers stand-alone operation if the central computer is disabled.

The security access system 14 makes the determination for access to physical buildings by activating a DC voltage signal to an electrical door solenoid or the like. The security access system 14 reads the incoming data string and determines access entry from its own database 34 parameters and conditions of entry.

The DC voltage signal is confirmation of user ID acceptance for entry. Therefore, this DC voltage signal can be further actioned, used, or re-transmitted in another format. A DC voltage signal would still be used to activate the door solenoid, but it can be accessed locally to the solenoid and applied locally by the IoT the receiver device. The security access system DC voltage signal is an acknowledgment that the user is allowed access with entry rights to at least one access point or entry door. Therefore, the DC voltage signal is confirmation of entry and can be used or re-transmitted to the door solenoid via Bluetooth or IoT instead of wires.

The above middleman approach by the controller 18 can be used in many different situations, for example, payment platforms. The above example is most applicable to global security systems.

The migration from wired insecure unidirectional communication systems to bidirectional or multi-directional networks is mandatory for flexible and secure operations. AI will add significantly to the capability of security access systems to defend against sophisticated attack scenarios.

Bluetooth and especially IoT systems are extremely expandable with secure encrypted RF transmission and network topology that allows any device on the network to be replaced seamlessly.

The additional ability to interface to Wi-Fi through an AI portal or channel allows an AI-powered system to integrate and enhance security seamlessly and much more effectively in real-time. The AI-powered interface could control all network device data flow and implement restrictions, prevent, or ameliorate many common attack scenarios.

Corporate customisation options with Bluetooth and IoT communications are required to the diversity of customer applications, languages, unique requirements, and expectations. Secure encrypted communications need to be flexible, secure, and easy to initialise or customise, either locally or remotely. Bluetooth, Wi-Fi and IoT generally operate at 2.5 GHz or above, which is much faster than heredity device transmission speeds. USB is increasing its bidirectional transmission speeds every year; therefore, these communication mediums are constantly evolving. The advantages of Bluetooth over NFC are its faster two-way traffic and ability to transmit images and languages at faster speeds, thereby opening scope for multiple use-cases. Transmitting the owner's image or other pertinent data lends itself to identification either locally or remotely for borders, airline boarding, health, policing & KYC applications, face or iris recognition offer a plethora of further applications.

NFC enabled credential IDs are normally stored in clear text, generally on a very simple integrated circuit (IC) operating at 125 KHz or 13.56 MHz, never changing their transmitted data. Therefore, the data can be copied and replayed, plus there is generally no biometrics user identification performed. Bluetooth or IoT changes these security weaknesses and introduces far greater scope and speed of transmission.

Bluetooth is extremely secure and flexible communication protocol and can require biometrics identification prior to operation, simply by using an App on the owner's smartphone or mobile device. An App or application can create or enable a Bluetooth output or communication session, following user biometrics identification. Therefore, the user's mobile device can be used as the initialization for the smart credentials, via a Bluetooth session. Using mobile devices greatly reduces the cost to the corporate entity or smart credential issuer and identifies the user/operator through biometrics.

Corporate customers select their encryption keys and load them into the user's credential devices 12, credential device readers 16, etc., from a standard smartphone or mobile device (associated device 20). Thereafter all subsequent data exchanges are conducted under a common encryption key and generally includes the associated device's IDs and the credential devices unique ID within the initialization algorithm. This process ensures that any further changes or updates to the credential device 12 can only be performed by the original associated device 20.

OTP encryption techniques are generated by including the credential device unique ID into the algorithm. The OTP secure communication solution ensures there is no capture and replay option on any transmission. The ability to use Bluetooth and IoT enables the same techniques to be used for logical network access. Therefore, the system for building security access can be applied to or expanded to computer network access and can expand further, using AI-based integration and networks, either IP or IoT based platforms can be further utilized.

Corporate, retailer or in-building IoT networks allow the retailer or operator to combine additional technology and peripherals together, offering enormous real-time information, which is capable to be re-transmitted to display devices and for a variety of other purposes. The credential device may include an E-INK display screen which allows information to be displayed, plus tracking. Bluetooth BLE adds to the trackability of the credential devices 12 when in-range of mobile phones or Bluetooth transceivers.

The credential devices can be used in automobiles, human operated equipment, high-value devices for tracking. Engineering overhaul, parts usage, component replacement schedules, or product use-by dates, plus inventory audits, which are all monitored and communicated by an IoT or BLE interface. An E-INK screen offers advertising revenue, multi-lingual support, image displays and notifications, alerts, updates, OTP and visual display variations for alerts or expiry.

A credential device 12 with an E-INK screen allows modification of the display, removal of displayed photo ID after a period of time or making a highlighted alert display change in an obvious manner. Thereafter, people become security wardens. People in an office or work environment can be the greatest security guarantors, especially as we all tend to review the badges or photo ID′S being worn by others. Therefore, any changes to the photo IDs are quickly recognized and appropriate action can be taken.

Workers can also quickly be evaluated if their ID photo has been removed or modified by a large display alert warning, such as ‘EXPIRED’ or ‘SUSPENDED’ or similar notifications are shown.

With the credential device 12, the internal digitally stored image can also be extracted and compared to the user, owner or wearer in real time. This leads to a biometric determination of the current bearer of the credential device 12.

Therefore, the ability to utilize a digital security credential device 12 for many different comparison techniques builds a more comprehensive security solution. By way of example, if a border control officer or policeman wishes to verify the ownership of a credential device 12, they can upload information to determine the original owner details. Encryption codes are used for uploading information and extracting data from the credential device 12. Extracting the stored digital image gives an immediate comparison of the individual in real time and without necessity for external communication network connections, determination can be localized by using simple mathematical encryption techniques.

Additionally, movement can be detected for safety or tracking purposes, the ability to determine movement and credential device 12 location offers several important informational parameters of workers or attendees at conferences or shopping mall. Tracking and tagging can be coordinated via many various technologies, IoT, Bluetooth, Wi-Fi, plus internal GPS sensors, and connections, within the smart credentials. When considering IoT tracking and tagging, each device 12 is a transceiver, therefore location measurements are established by device-to-device transmission, and all inputs.

The credential device 12 with E-INK display, biometrics, and IoT provides a wide range of security options to enhance authentication, authorization, and overall security or identity. By leveraging and combining these technologies, organizations can achieve a more comprehensive security solution.

E-ink displays allow for easy visual recognition of credentials, with the ability to change the display after a certain period or highlighting changes in an easily recognizable manner. This can significantly improve the verification process, making it more difficult for unauthorized individuals to gain access to secure areas or resources.

Biometrics, such as fingerprints or facial recognition, can be incorporated into the credential devices 12, providing an additional layer of security. These features can be used in conjunction with digital certificates, credentials, and passwords for secure B2B and B2C e-commerce, as well as the encryption of sensitive data.

IoT technology can be utilized to create digital locks and other security systems for home and business applications. By integrating AI, Blockchain, IoT, and biometric systems, the credential devices 12 can offer enhanced security and access identity, either locally or remotely.

The credential devices 12 can utilize AI to discover and control rogue devices, non-compliant IoT devices, and malicious applications to protect against potential threats.

Secure data key synchronization algorithms can be employed to ensure secure communication between the credential devices 12 and any verification systems, further enhancing overall security.

PKI-based mobile smart credentials allow for high integrity and substitute for insecure static-password authentication, providing an additional layer of protection against unauthorized access.

IoT-based projects such as smart agricultural systems can also leverage smart credentials to manage and monitor farming tasks securely.

Advanced security features, such as credential vaults and just-in-time access protocols, can be used to distinguish smart credentials (credential devices 12) from the rest, providing extra security layers. Finally, seamless integration of multiple technologies and gate access systems can be achieved using wall readers, which can easily adapt to smart credentials with E-INK dynamic displays, biometrics, and IoT.

Operating as a smart home device controller, an IR interface can be added. The smart credential can store passwords, which can then be manually or digitally input to computer networks via Bluetooth, Typing or USB. Digitally entering Passwords via Bluetooth or USB or emulating a keyboard or computer mouse, enables Passwords, or OTP (One Time Passwords) to be longer and more difficult to decipher, plus can be transferred to computer or mobile device without visible display, enhancing the security further.

The smart credential E-INK display contains multiple selectable logical or virtual smart credentials. Therefore, each smart credential could include a tagging or tracking option. The tagging, tracking and distance determining features, which are based on RF, GPS, Bluetooth and IoT technologies, combine with precision. The ability to tag anything with IoT has enormous advantages, and operates in any environment, offering detailed information of the tagged items, their approximate location and if Detected or NOT Detected. The display could look like the following representation: Car, 150′, Detected; Wallet, 50′, Detected; Children,-, NOT Detected; Garage Door, 300′, Detected Open; Front Door, 30′, Detected Locked; Outside Light, 80′, On.

The smart credential could also include technology to ping mobile phone towers, vastly increasing tagging and tracking options without substantial additional costs. Utilizing the smart credentials with automotive and tracking capabilities builds a multi-purpose structure to the smart credential that is selected and initialized from the mobile device application, creating far-reaching options and versatility with multi-use and multi-lingual display options, plus voice control and voice or buzzer output. Hearing impaired and visually limited people or the elderly could have a customized solution based on their needs and restricted human capabilities or health alongside their safety requirements.

The display of smart credentials is initialized from a mobile device and might be additionally selected as a ‘smart things’ device but are essentially autonomous smart credentials with commensurate operating systems. The setup and display layout are created in the associated mobile device application with AI assistance, which also combines the devices through IoT, Bluetooth or USB, under a common encryption key or multiple hierarchical encryption keys.

The mobile device application integrates with an AI application to initialize smart credentials. AI assists with display configurations, limitations of different display types or sizes, acceptable display versions, allowable images that are within the parameters of the specific smart credential. The smart credential display might vary from device to device and could require an intelligent application combining with some form of AI assistance. Simple displays such as photo ID or baggage tagging smart credentials containing limited and related information might be preset into the device and require little or no initialization setup from mobile devices.

The mobile device application also configures the ‘logical’ smart credentials with multiple device options, which are then selected by the credential operator or user and might include the following:

Tagging or tracking logical credentials.

Password, wallet, money, digital currencies, photos etc., off phone storage and retrieval.

Digital ID for interrogation by government officers.

Name, Health, address, or other personal information.

Corporate cards contain health determination by temperature or other checking technologies.

OTP, One Time Password generation or ‘challenge-response’ certificates.

Long range communications and protocol conversions to security access systems, i.e. Wiegand data, financial payment protocols.

Display time-out functions.

Date and Time functions.

Garage opening, door and valuable devices, various personal or home functions.

Automotive and license operating and expiry details, pilots etc.

Passports and border controls, personal security, KYC financial information gathering.

Ability to turn biometrics on, depending on the credential type or level of security desired.

Combined logical (digital) and physical (building) security credential, all-in-one solution.

The smart secure credential contains a unique ID, therefore ensures that every credential is unique from manufacture, this is like mobile phone ID's or UID's, unique identifier, which is also found in computers and laptops. The smart credential additionally contains user biometrics data. The smart credential can generate OTP, One Time Passwords, store traditional Passwords and personal data, for display or identification purposes. With all these attributes, it is then possible to extrapolate the options for using the smart credential in multiple ways, for physical and logical, network access.

The benefit of generating OTP is their dynamic non-replay able nature and ability to increase their length and structure of character strings. Corporate Static Passwords can be enhanced or replaced by using the employee smart credentials' unique features that create a multi-use security option, both for physical access with NFC, IoT or Bluetooth, plus network login with a generated OTP, based around the smart credential's unique identifier. The incorporation of unique identifier in the encryption process to generate the OTP enables corporate network online validation of the employee in the same way as the physical access or building management system. The process also enables the access medium, computer, laptop, or mobile device to remain discoverable during the session for additional reference. This scenario introduces multiple device security, requiring at least two user devices to be discoverable throughout the session.

Therefore, a smart credential has the capacity for multiple function operations, as above, and can contain the security keys for mobile device access, allowing login or password changes. The ability to utilize the unique features of a corporate security smart credential in so many daily tasks is due to the flexibility of the ‘logical’ devices that are setup by the manufacturer, distributors, corporate or governments etc., under the highest security processes and combining in a comprehensive multi-purpose manner, based on the desired operational or application parameters.

The ability to communicate over long distances with fast, secure read and write data flow, allows mounting of the credential technology in ceilings, closets and wall mounted or desktop applications. These include corporate offices, residential, retail, and commercial applications.

Wall mounted credentials can integrate a camera or LED lights. For additionally security, the wall mounted smart credentials may upload the presented user credential digital photo or signature image and biometrically process a fast one-to-one comparison for effective and secure facial, iris, or other unique human feature comparisons. Touch display also enables keypad functions, password input, static or rolling code OTP entries can be accommodated etc.

A smart credential wall reader without battery or with rechargeable battery, can be operated and charged by presentation of the smartphone or equivalent Qi2 Wireless charging technology. The access control wall or desktop smart reader maintains the E-INK image display without any ongoing requirement for energy or power. When the smartphone is placed on the smart credential reader, it immediately draws Qi2 or equivalent Wireless charging power, affording operational capability. This is a reverse scenario to the normal approach, where the reader powers the NFC credential.

This scenario allows a static reading device to remain unconnected or unwired and simply await the activation from a power source, which might be supplied from a smartphone. The reading device will have been previously initialized from a smartphone for its application parameters that are activated upon presentation of a smartphone or equivalent Qi charging technology. The smartphone might contain the accepted encryption keys and Bluetooth or NFC IDs for operation or might have a smart credential attached in between the smartphone and wall reader, which is used as the security device.

The advantage of a battery-less or rechargeable battery-operated reader is that it can be located remotely and operated for years. IoT interface allows long distance communications. The smartphone can hold a smart credential between itself and the reader. The reader then activates IoT to allow operation on/off, plus open/close controls etc.

The smart credential or smart reader may incorporate super-caps to charge almost instantly and reduce the waiting time of the transaction or for the purpose of storing energy. The reader can communicate with the smartphone by NFC or Bluetooth BLE, or the reader can communicate with the smart credential via IoT.

A smart reader may contain LED lights and be placed near a Qi2 Wireless charger to gain power through a physical medium, such as ceiling or wall. When combined with IoT, the smart reader can provide lighting to an area and be turned off or on remotely or operated via movement sensors. The advantage of using Qi2 is the incorporation of magnets that hold the smart reader or credential in any orientation, upside down etc. The ability to place a smart credential or smart reader with LED or low-powered lights is the ability to maintain mobility or avoid holes in walls and ceilings etc.

Another version of remote or nearby Wireless charging with Qi or Qi2 technology is the ability to supply power to a physical door. An access or entry smart reader can be placed within a physical door, like hotel entry readers. However, the smart reader with Qi or Qi2 capability can accept the power from nearby Qi power sources without physical attachments, such as wires or batteries.

The ability to utilize smart readers or smart credentials without batteries, or possibly with longer life rechargeable batteries and super caps, ensures operation over many years. Smart readers and smart credentials operating as a lighting source without batteries or wired connections, offers many more flexible and versatile application scenarios.

In a military or government contractor scenario, everyone has a smart credential for verification of identification, personal data, pertinent location information, plus visual determination of photo ID for security. Internally stored digital images are available to an interrogator. The process of extracting information or data from the smart credential is conducted over an encrypted communication link, derived from the credential unique ID, enhancing the flexibility and for enhanced security purposes.

The military smart credential may have temperature sensing and therefore can determine the owner's health, emotional state, or health condition. Therefore, an ability to determine this information in real time and with confidence is a significant advantage. Additionally, firearms, valuable equipment, vehicles and equipment of any sort or nature are also tagged and tracked, plus their operational status can be determined from the temperature and other environmental determinants built into the device.

Utilizing the IoT network enables communications with voice, plus alerts, notifications, warnings, or commands to be sent in complete security and with total confidence. The message being sent also can await a response/confirmation message; this can be especially critical knowledge.

Using more diverse smart home applications expands the IoT network over longer distances because each smart credential can also be an RF connected device. Longer distance operations offer external or outdoors control functions, garage, lighting and other remote-control options.

A wall mounted or desktop display could include time clock, calendar or personal photos, or a combination of these. Changing from one display to another could be triggered by user smart credentials entering the IoT communication range and further determined by Bluetooth range to their mobile device or TV etc. This offers the wall mounted or desktop mounted smart credential to display different images for different purposes or for different physical locations, or as setup in the initialization phase from the mobile device application.

Using all the local technology components, the smart credential can react to external inputs in several ways, as programmed or setup in the initialization phase. The options are endless. Using smarter credentials in each environment creates greater flexibility and longer distance connections.

The vehicle could contain a smart credential with pertinent information about the vehicle parameters and special requirements for the operator or driver. The smart credential in the vehicle first approves the user smart credential before allowing the vehicle to function. This same approval process could be used for firearms, chemicals, drugs, airlines, access identification, in hotels or allowing alcohol purchases by user credentials that exceed minimum age restrictions.

This technology interrogation system may be used to deny operation or service to individuals that are impaired for any reason, drugs, alcohol, age, or human deficiencies.

Border control and passport authenticity could combine with vehicle or user smart credential, making such systems far more secure, robust, and more easily deployed in urban or remote locations. A plethora of advantages then extrapolates from the interrelationship of user device and vehicle.

Smart credentials inside vehicles, planes, commercial control systems can enhance security and ensure the operation is conducted by licensed individuals. For instance, a smart credential is placed in a hidden location in the vehicle, then, if a non-licensed individual is attempting to operate or conduct theft, an alert system is activated, and the vehicle is disabled from any operation.

The above solution ensures workplace safety and military or government regulations are enforced, sometimes without officers or human intervention. The smart credential could have Bluetooth connections within Apple or Samsung tag tracking ecosystems, Wi-Fi, mobile tower pinging functions, IoT networking or any GPS function or connections, as desired or as requested or initially setup in the manufacturing/initialization phases.

The initialization phases could utilize AI to organize, restrict or manage the parameters of inputs into the smart credentials. AI would be able to communicate with the user at the initialization phase to determine the parameters, inputs, outputs, features, functions and display restrictions for images, advertising, notifications, and general layout limitations of different sized smart credentials etc.

Combining conducive technologies affords greater security and scope, offers significantly greater determination and certainty of identification, classification, licensing, physical capacity etc. Combining with Apple and Samsung tracking ecosystems via BLE or IoT and user or vehicle credential is complimentary and security enhancing. Additionally, determining driver and vehicle credentials, location, operator health, medical conditions or restrictions and non-expiry of vehicle registration or components are all critical factors to be disseminated. These parameters all combine to create greater certainty and ensure more regulation can be applied and thereafter enforced.

Additionally, adding NFC to the smart credentials offers interaction with mobile device security keys and upgrades the implementation of any existing security device with a comprehensive smart user credential that has multiple operational characteristics and several facets of flexible operation or technology integration. This in turn allows an upgrade path for NFC to a higher security technology.

Smart credentials at significantly lower selling prices are an important adjunct technology to mobile phones, especially when combined with IoT. Smart user or vehicle credential setup is application enhancing, plus with far greater secure. Smart credentials can be user configured for each application, whereas mobile devices come in one configuration only, off-the-shelf.

The benefits of using smart credentials with IoT compared to mobile phones is the many advantages incorporated, offered, and implied. The smart credentials provide enhanced security, customization, multi-application and combined technologies or very specific functions. While mobile devices come in a single, pre-configured format, smart credentials can be tailored to meet the various needs of individuals, governments, corporations, or vehicular operation etc. Some of the key benefits of smart credentials include their flexibility and diverse use-cases, such as, payments, IDs, mobile telephony, and health, security, connecting user devices over IoT or RF magnetic inductive communications. Connecting or accessing data across multiple clouds and networks, without restriction, plus using an AI oversight determinant for further security and larger, more complex capabilities.

Remote RF or over-the-air provisioning of operator credentials, enhancing security and ease of use.

Compatibility with various smart home ecosystems, such as Amazon Alexa, Apple HomeKit, and Google Home. Considering these advantages, smart credentials at lower selling prices can prove to be a better choice than mobile phones in the context of IoT, customization and long-range connectivity.

Wireless IoT networks offer several advantages over wired connections, making them an increasingly popular choice for access reader systems and other IoT devices. Key advantages include:

1. Cost savings: Installing a wireless IoT network eliminates the need for expensive cabling and infrastructure required for wired connections. This can translate into significant savings, particularly for large-scale installations or in situations where access points are spread across a wide area.

2. Scalability: Wireless networks are much easier to scale up or down as needed. Adding new access points or IoT devices to the network simply requires connecting them to the existing wireless infrastructure, without the need for additional cabling or physical modifications.

3. Flexibility: Wireless IoT networks offer greater flexibility in terms of device placement and network design. Devices can be placed anywhere within the wireless network's range, without being constrained by cable lengths or physical barriers. This makes it easier to adapt the network to changing requirements or to expand coverage to new areas.

4. Resilience: In a wireless IoT network, access readers and other devices can fail without impacting the overall network functionality. This is because, in a mesh network, devices can communicate with each other through multiple paths, allowing for redundancy and ensuring continued operation even in case of individual device failures.

5. Enhanced security: Wireless IoT networks can leverage advanced encryption and authentication protocols to ensure secure communication between devices, deterring malicious activity and protecting sensitive information. Furthermore, the ability to monitor and control the network remotely allows for faster response to potential security threats.

6. Simplified maintenance: With no physical cables to maintain or troubleshoot, wireless IoT networks require less maintenance, resulting in lower ongoing costs and reduced downtime.

7. Real-time data: Wireless IoT networks enable real-time data transmission between access readers and other devices, allowing for faster decision-making and more efficient operations.

8. Easier integration: Many IoT devices are designed to work seamlessly with wireless networks, making integration with existing systems more straightforward.

Bidirectional secure send and receive network systems, such as those employed in wireless IoT access control environments, offer several advantages over traditional send-only, wired networks. These advantages can lead to improved performance, greater security, and increased flexibility in access control reader systems.

1. Bidirectional communication: Send and receive networks enable two-way communication between access control devices and the central system. This allows devices to not only send data but also receive commands and updates from the central system. This bidirectional communication enhances the overall efficiency of the system and enables real-time monitoring and control.

2. Dynamic configuration: With true send and receive capabilities, network administrators can dynamically update access control configurations and policies. This can include adding or removing user access rights or updating security measures in real-time without having to physically interact with each reader.

3. Enhanced security: Send and receive networks allow for more advanced security features, such as encryption and authentication, to be implemented within the access control system. This prevents unauthorized individuals from intercepting communication between devices and ensures that only authorized personnel can access the system.

4. Real-time monitoring and alerts: Two-way communication allows for real-time monitoring of access control readers, enabling administrators to track activity and receive instant alerts if any unusual events or security breaches occur. This can help organizations respond more quickly to potential issues and ensure the safety of the premises.

5. Improved diagnostics and maintenance: In a send and receive network, access control devices can report their status and any issues they are experiencing to the central system. This enables administrators to diagnose and address problems remotely, reducing the need for physical maintenance and helping to minimize downtime.

6. Network efficiency: A send and receive network can more efficiently manage bandwidth and reduce congestion, as devices can intelligently communicate with the central system in real-time. This can lead to improved network performance and stability.

7. Easier integration: Send and receive networks support more seamless integration with other systems and devices, like security cameras, alarm systems, and building automation, allowing organizations to create more comprehensive security and facility management solutions.

In conclusion, send and receive networks in access control reader systems offer numerous advantages over traditional send-only, wired networks. These benefits include enhanced security, real-time monitoring, improved diagnostics and maintenance, advertising potential, and greater overall network efficiency. As access control technology continues to evolve, sending, and receive networks will likely become an essential component of advanced access control solutions.

Importantly, if NFC remains the sole identity or access entry detection (or payment connection) from the smart credential, the biometrics phase can be initiated as a self-contained action, which stops the NFC entry or payment phase until the user is biometrically confirmed, depending on the level of security desired or preset. This system doesn't require back-end communications to a security access control platform as it conducts identity verification between user credential and wall mounted reader locally and in pre-requisite steps. This system works very effectively when adapting to existing NFC platforms, off-line or cut-off from security networks, but requiring greater identification security.

Once the above process is conducted, the user credential could be loaded with daily password or OTP updates for logical access platforms, networks, computers etc. Additionally, the user credential could have updated information displayed on their user credential, including photo ID, user info, user zones etc., time frame of access, monetary allocations for meals and coffee etc. Advertising display could also be updated, depending on how the user credential was setup and depending on AI priorities.

Additionally, the above NFC interface still allows the smart credential to further link to time management systems over an IoT network for determining statistics or attendance. The IoT computer network could enable the user to operate their workstation, plus transform their static password to an OTP, to enhance security of the entire workplace, physical and logical security.

NFC readers may still be utilized by combining protocol technologies, biometrics, and smart devices into a connected secure network. The ability to add IoT connected devices increases operational range of RF communications and brings a greater certainty of identity, location, plus statistics of movement etc. AI supplements and brings real control and management oversight for detecting any variations from historical normalcy, which are quickly detected, and preventative action taken.

The above system uses low-cost NFC devices and is easily and quickly installed and configured by a Wireless IoT network. The system works for local or remote identity, location and status with statistical analysis and AI oversight. Such information is stored within the smartphone.

Combining multiple devices together increases security in the same manner as combining biometrics features together. Multi-modal techniques of within-range devices is another mechanism for confirming identity, location, or health. Logging into a computer might require a mobile device (unlocked) in combination with a smart credential. Fingerprints or other biometrics is an additional security component to identify authorized users. Certain situations where device to device recognition or within-range detection could be advantageous, in that, a user cannot leave the house without keys for re-entry. The combination of devices requirement is setup in the mobile device application initialization phase of the smart credential, including with AI support.

Further example, the user cannot leave a tagged dog or cat inside, nor other valuables as is pre-defined at the initialization phase and in conjunction with AI. Valuables in safes or locked cabinets, gun cabinets etc., cannot be unlocked unless multiple devices meet the pre-configured criteria established in the mobile phone initialization of the smart credential or as desired in later iterations.

Most cars are stolen by stealing the remote or the remote's encrypted communication protocol and simply driving away. However, the automobile could be further secured or prevented from opening if a smart credential is used. Smart credentials are more suitable for increasing security effectiveness because they offer long range detection and contain more secure encryption algorithms.

AI greatly assists in the initialization process from the mobile phone for smart credentials. AI allows simple text or voice to select the combination of devices required to be detected before any action is performed. For instance, you cannot open the garage door unless you detect my smart credential and my mobile phone, combining the unique identifiers of both. The smart credential would inhibit the garage door from functioning until multiple devices are detected, which may include variables of devices, alternative devices in some circumstances may be optionally required. An AI-IoT environment allows device to device secure communications and detection, all are connected by one protocol or another. All devices can be combined from a smart credential with AI and multiple technology protocols inbuilt. Operational applications are defined and programmed into the smart credential at initialization time or later, as user requirements change or adapt. Communication with each device is constant and automatic without user intervention.

AI assists with such preset or desired activation or operational applications, based on the setup or initialization from the mobile phone App. The mobile phone App or application may integrate with the user selections to make suggestions or prompt the setup conditions that will be conducive to the environment. This process may occur after operational tests or considerations that AI could assist.

AI could allow the user to activate outputs for specific actions that are not preset or initialized into the smart credential. For instance, AI could be instructed by voice, environment, touch screen etc., to turn on a light or change color. AI could be on standby to conduct certain control signals and would need decide which control signal and whether a controllable device is in range and operable. The outputs will vary from RF, magnetic inductive, Bluetooth, Wi-Fi, IoT, USB or other control signals that are available and required to perform the task, which AI would determine.

A fragmenting society requires information dissemination that conveys specific data, news, or comments to be shown in a variety of media platforms. The ability to combine long life dynamic displays with battery for power and IoT for Wireless communications, offers effective visual displays for a multitude of applications. Additionally, the IoT interface propagates the IoT network over longer distances through their RF transceiver capabilities. Thereafter a wider area network over IoT transceiver gateways exists. A wide network of connected devices creates a platform that distributes information on multi-media over significant distances.

A user might have certain information categories that pertain to their business, foods, drinks, cars, and might further categorize this information as desired. The smart secure credential can decipher and collect this information from a variety of communication protocols. These protocols could be operated in malls, the workplace, gatherings, conferences, hospitals, government, military etc.

The ability to determine advertising or information on a low cost, low power, long range display medium, such as e-ink and IT together, creates an environment defined by groups, employers, advertisers, sensitive or pertinent information collectors or controllers.

The smart credentials can display information received if the conditions of display are setup appropriately. The operators or controllers of the smart credential may conduct certain actions when the credential has entered the area. Therefore, tracking or location determination of the smart credentials, combined with authority to change or modify the dynamic display, offers real-time events. AI understands the dynamics of all inputs and the display physical limitations or restrictions and can convey intelligent notification events to the user, based on location or other determinants.

The smart credential has inbuilt advanced technologies and offers even greater security when combined with 2 factor authentication, reducing the complexity, and rendering the user password memory requirements unnecessary. The user no longer needs to memorize ID's or Passwords. Security and 2 factor security are bolstered by the smart credential and AI combination. The smart credential's ability to determine its environment, its in-range connected devices over, IoT, Bluetooth, USB, NFC, or Biometrics determinants are significant. Therefore, the requirement to enact 2 factor authentication is upgraded by more secure and simpler processes that are based on determination of the proximity of connected devices, location, time of day or connections to family or trusted devices, as pre-configured in the smart credentials and assisted in most cases by AI real-time techniques.

In addition, notifications and preferred news sources or desired websites, such as Twitter, Facebook and YouTube could be allowed as acceptable interfaces, selected by voice or AI. The security is enhanced and based on pre-determined interface restrictions. The smart secure credentials become our trusted device that defends intelligently with AI against external attack scenarios whilst constantly determining the user and their environment.

A multi-polar world requires new avenues for advertisers and promoters, corporates, government, military and store owners, retailers etc. A secure smart credential is fully customizable and would fit into a multi-polar world more effectively and more securely than mobile devices as we know them today. There are untapped markets, such as elderly, youth, security conscious, lay-people etc., or people wanting minimalized connectivity options in their daily lives. Smart secure credentials fill this void. Smart credentials can be even more preferred due to their customizable architecture and AI assistance. These devices are far simpler, far more secure and far more adaptable than mobile devices and vehicle or control-credentials, as we know them today.

Personalized Marketing to a known user, gives more understanding of preferences, identity and affords greater scope in determining the environment. The diversity of data and information available creates a unique opportunity for advertisers and services, news, or special interest groups, such as gun lobbies etc. Secure smart credentials offer a low power, low cost, high security and true multi-function, customizable device/solution, endlessly expansive, especially when combined with AI.

Marketing concepts of the future must adapt to a multi-polar world and a fracturing information targeted media strategy, which is driven by narratives and financial success. Extracting specific marketing data from all publications and websites is demanded and invaluable to today's society. We prefer more summarized plain language and pertinent information. Multiple platform providers vie for our attention and viewership, such as Facebook, Twitter, X′, or YouTube. A smart secure credential would filter the information into a summarized format, that has been transitioned and processed through AI and customized by the user. Therefore, the user selects more concise and relevant information based on AI their pre-defined preferences. This allows AI to do all the searching and ensures only concise relevant information is sent to the user, within a security firewall.

Importantly, AI also filters out viruses and attack scenarios on behalf of the smart credential. The secure smart credential already contains several security enhancements over typical incumbent security procedures, as used today. When combining the inherent smart credentials with AI, the security and defensive firewalls increase in strength and certainty, also AI reduces the workload of the user, they don't need check everything before opening a news article or reading a notification. The data stored internally is spread amongst non-volatile storage memory, negating attempts to scan or decipher sensitive information, images, photos, images, digital or real-world financial information.

AI can determine information or music from multiple devices in range or online from a plethora of sites that cater to user requests, moods, number of people detected, time of day, and criteria established.

The secure smart credential combining with certainty of user identity and their preset preferences can filter information from several sources. This information can also be compared across multiple sources to determine accuracy or percentage of authenticity, thereby delivering content that is relevant and with a reasonable assumption of accuracy. Smart secure credentials are a giant leap forward in user identification, user information filtering and user security, across multiple devices and platforms. The low-cost user credential significantly simplifies the process of gathering pertinent data and ensures reasonable accuracy.

Larger screen PAD's or Kindle style iterations of the smart credential can operate as wall or desk mounted devices that continuously update their memory and notify the user of new media collection or other relevant information, via AI. This media collection solution is preset by the user to collect relevant data from authentic sources and verified for accuracy, mainly via AI. The information can be displayed on a larger scale screen display whilst remaining portable and battery operated, always connected by IoT, Bluetooth etc. to coexist in the ecosystem of the smart secure credential.

When a smart credential functioning as an ID, tag, passport, boarding pass, driving license or other device is operated with an AI engine, the ability to assist the process of determining identification or device ownership is enhanced. AI can assist or fully function in either online or offline modes.

AI can be used in the interrogation device carried by humans or integrated into any device and then used in the interrogation process. Therefore, both the smart credential card and reading device can utilize AI for a variety of purposes.

The following examples highlight how AI can be integrated into the operational process, either partially or fully, to improve efficiency and produce more accurate results.

Use AI to switch between logical or virtual devices.

Use AI in wall mount devices to interrogate any other inputs in real-time.

Use AI in the user device, plus in the wall mounted device to enhance security or identification.

Use AI in the user device to determine which logical device and display is required, given the voice command, external inputs, location, or other inputs.

Use AI in the user device to facilitate decisions by also including user temperature or health measurements in the decision-making process.

Use AI to understand patterns of usage to predict future actions or predict normal actions.

Use AI to track the user credential and report anomalies or operating in restricted locations.

Use AI to cross-determine cashcard remaining values after retailer or transportation transactions.

Use AI to consolidate or transform NFC data from transaction information.

Security on smartphones is continuously compromised and no longer trusted. We need a new technological solution to return confidence to users, improve their security and bring trust by utilizing the smartphone's own capacity. An adjunct card inserted into a smartphone transparent case, would create a considerable security advantage by using cryptography or passkeys, totally replacing passwords.

We can adapt or upgrade plastic cards with state-of-the-art technology and combine with our smartphone to supplement its existing biometrics security, prove our identity, whilst broadening the AI technology protection sphere.

An adjunct card/credential for our smartphone promotes adaptability, multi-use capability and security. Smart credentials associated smartphone app with AI-PORTAL then monitors and manages the secure website connections and communications.

The Smart credentials can be removed from the smartphone to operate other devices or used on access security, payment readers, utilizing the internal electronic power source. The internal power source is typically super-caps that are almost instantaneously charged when used on access or payment readers and smartphones. Smart credentials can also operate with a battery or commensurate technology.

Smart credentials are configured by the smartphone for autonomous applications thereafter, with or without network access. The AI-PORTAL is an integral part of the system that ensures security and connectivity and monitors all aspects of multiple multi-lingual dynamic image virtual display cards.

Multiple Virtual Customizable cards offer an unparalleled consumer experience, including self-designed images, logos, or owner's name, whilst integrating everyday applications, such as Octopus, Oyster, Access ID. Digital smart credential card owners can now personalize their cards in a unique and informative manner.

The AI-PORTAL smartphone App interface ensures that limits are set on the number of virtual cards and all outbound communication parameters are implemented to complement the daily requirements of the user or the issuer.

Each Multiple Virtual display and associated communications selections could be automatically selected by their environment, adjusting the operating frequency or encryption codes, then allows the smart credentials to select the associated active display image. Using smart credentials to make a transportation payment, such as Octopus, brings the pre-defined Octopus display to the active display, remaining in operation until another application is automatically or manually selected.

Although there are complications in setting up a multi-tasking, multi-usage device, it can be mostly pre-configured by institutions, thereby restricting or limiting user options. When combined with AI techniques and volume sales of a particular type, these setup conditions can be automated. The ability to totally define the nature and operation of the smart secure credential is a huge advantage.

Smart credentials operate as an adjunct to smartphones, both obtaining power or energy and converting Bluetooth to long range IoT. This extends the operating range to cover long distances over a secure encrypted standalone network. Wireless networks are commonplace, and Wireless solutions are accelerating as the technology updates; therefore, we expect cumbersome Wires will inevitably disappear from our workspace.

Wireless systems are now more secure, more flexible, more decluttered, more easily deployed and cost far less than Wired, therefore it makes total sense this trend continues to accelerate and become ubiquitous. Smartphones operate with the Smart credentials app and coexist with the smart credentials to manage displayed images, advertisements, whilst controlling the layout of displays.

Smart credentials transform Bluetooth into secure IoT communications, allowing control of any associated IoT device with trust, convenience, security, and flexibility.

Smart credentials operate as an adjunct to smartphones, both obtaining power or energy, plus communications. Bluetooth BLE is a secure communications protocol, operated from a smartphone App and utilizing AI for greater security and control. Wireless charging ‘Qi2’ is a global standard that enables third party devices to be charged whilst in proximity. Smart credentials combine these technologies together to create a secure off-phone card storage medium with optional AI oversight, to ensure smartphone manufacturers cannot monopolize or manipulate their position.

Smartphones are powerful electronic computing devices, which are controlled by the manufacturer through their operating system. Therefore, they can be limited in application by the manufacturer to assert their control and they are open to malware attacks due to their published architecture and features. Smart credentials dynamic display cards don't allow third party Apps, nor external notifications, nor publish the operating system. Smart credentials offer a unique secure off-phone alternative, ensuring open compatibility with all smartphone competitors.

Smartphones operate with the smart credentials App and communicate via secure Bluetooth BLE. Smart credentials AI App manages displayed images, advertisements, secure memory storage, plus configuring the layout and applications of various e-ink display mediums.

Digital Wallets store sensitive user photos and bank account information, social security, and personal data, which requires strong data protection. Smart credentials use Bluetooth to store sensitive information off-phone with AI management.

Smart credentials adjunct card technology can fulfill a transformative action, in that, when Apple sends a formatted message to an Android device, the smart credential can transform the transmission to match the receiving device format. This overcomes degradation of transmitted data and content from different smartphone manufacturers.

Some smartphone manufacturers store user data or images and transmit them perfectly to same-type smartphones; however, the images and data are deliberately downgraded when communicating with competitor smartphones. Storing information on the smart credential's dynamic display ensures that the data is not modified nor manipulated.

Some smartphone manufacturers provide a digital storage App; however, the credit and debit card information are restricted to their own preferences, possibly affording the manufacturer transaction fees and other incentives, which are most probably unknown to the user.

Some smartphone manufacturers back-up user data in cloud storage, which is insecure and open to many attack scenarios. Smart credentials rely on the secure local Bluetooth communication only, not enabling many favored malwares or cyberattacks.

Smart credentials use E-INK dynamic display cards on the reverse side of smartphones, or for autonomous use. A secure smartphone AI-PORTAL App, plus Qi2 charging with BLE conversion to IoT, are an ideal combination. Adding E-INK then offers a low power interactive multi-lingual display, enhancing capabilities and real-world applications. When smart credentials are attached to the reverse side of smartphones, they create an IoT ecosystem, and a very visible 2nd display. Advertising options have areas for growth with recurring revenue options. In summary, enhancing the common static plastic card with new dynamic displays creates a favorable market potential.

Smart credentials AI-PORTAL operates as a security assistant, validity checker and ongoing operational oversight, allowing or denying access to Apple Store, Apple ID, Google Pay, Passkeys, using internal stored spread-memory encrypted user Passwords and manufacturers unique ID.

‘AI’ is capable to update the smart credentials with ‘expired’ or ‘suspended’ notifications or timed alerts, due to payment infractions, suspensions, etc., greatly enhancing revenue whilst reducing insurance premiums. Payment cards with dynamic E-INK displays can be visually voided when attempting operation at financial Payment Terminals.

Smart credentials combine IoT and Qi2 communication and charging technologies. These technologies will combine for a variety of functions, from access control wall readers to payments, configured from the smartphone AI App. Secure Wireless communications and Qi2 Wireless charging will dominate the landscape of the future. Smartphones already support Qi2 charging. Current NFC reader devices perform the role of powering and communication with NFC cards. Qi2 will replace this technology and encompass more secure communications and more power or energy for enhanced performance.

The comparison below demonstrates how the older NFC technology operated and how Qi2 gains far greater capability, whilst operated in a similar manner. Therefore, encouraging user acceptance and intuitive use. NFC's Power Harvesting capabilities caps at 50 mW, due to the existing technology that's on the market today. Whereas Qi2 technology delivers 15W, gaining a 30,000% advantage and will increase further.

Smart credentials AI App will enable support to all IoT, BLE and NFC hardware devices, giving oversight and clarity to the surrounding (in-range) devices. Smart credentials technology will communicate with all NFC, BLE & IoT devices, the AI App has access to the corresponding data and interface specifications, affording comprehensive connectivity in a seamless user-friendly manner.

The Global security market for payments is bulging with a diversity of technologies, creating an environment that is cumbersome and complex. Smart credentials patented payment platform transforms the current fragmented global payment system by accommodating all existing technologies and combining with a secure AI Wireless platform. Smart credentials utilize AI to initialize the ISO card and reader, including a unique ID for enhanced security and encryption, and reducing copy replication techniques. The back of the ISO card will be configured by the user in a known, orchestrated manner by smartphone and AI App. IT is utilized as a secure transmission medium in-store, which offers multi-device interaction, cameras, marketing, tracking etc.

### Applications

Smart credentials, E-INK desktop/mobile payment readers accept all existing technologies and transmit the user data over secure IoT. The reader converts the data from the user card into the IoT ecosystem and back to the issuing server in the required protocol.

No changes to existing bank interface as the data is re-configured inside the Smart credentials Controller before being delivered.

Current global payment readers and ISO cards and credentials are unchanged after more than 40 years of service. It's time to change!

Create and build new IoT product designs and unique marketing concepts for open architecture connectivity, integrating multi-devices and multi-interfaces, Qi2, NFC, Biometrics, IoT & E-INK.

E-INK offers advertising revenue, multi-lingual support, image displays and notifications, alerts, updates etc. etc.

Smart credentials E-INK dynamic display can be made visually ‘VOID’ by over-writing the display. Warnings and alerts can be sent to the reader for the retailer to be aware.

The Smart credentials are posted (mailed) to the owner, same as today. The owner downloads an AI App on his smartphone, which displays the basic card format. The owner adds his image, PIN, plus signature or name. Completed entirely remotely by the user.

The smart credential's owner then contacts the issuing bank, same as today, and confirms they have received their card and that it has been initialized by the AI App.

The face of the Smart credentials card remains the same, printed with the relevant information, including the IC chip and magnetic stripe. The reverse of the card is an E-INK display and will ‘optionally’ show the owner's photo image, card number, rolling or dynamic authentication number/security code, logo, advertising, etc.

The owner's PIN, digital facial image, unique ID of the Trust-Card will be stored internally in secure non-volatile memory. The transaction with a smart credential's payment terminal will be preferably completed via Bluetooth BLE, due to its enhanced security. The QR Code will be disseminated within the card and converted to Bluetooth BLE. The owner's PIN will be transferred by Bluetooth during the transaction. Therefore, Smart credentials streamline the transaction by accepting all current technologies and converting them as required to a more secure format.

Smart credentials readers can use the internal owner digital image as a biometric comparison, in real-time with the user, this adds significantly to its security.

The owner does not need to remember or input their PIN. The owner's digital signature and photo ID are displayed for real-time verification by the retailer. The unique card ID is transmitted and monitored by the AI system, limiting card cloning.

The smart credentials payment terminal can be combined physically with the smart credentials Controller, offering a single device mobile operation.

The smart credentials payment system can be re-configured and adapted to other industries, health cards, access cards, passports, licenses etc.

Qi2 charging is used to ensure the smart credentials ISO cards have sufficient power to operate and may be used as the initiator for change of the rolling security code. Every time the Smart credentials card is used, the rolling security code advances. The rolling code may be displayed or updated internally for each new transaction. Therefore, once it has been displayed and used, it is no longer valid, nobody can watch and replay.

AI is the main advantage of the Smart credentials payment system because it is involved in every facet of the initialization of readers/controller/cards, monitoring and reporting thereafter.

Qi2 offers sufficient power to power the card technologies and modify the display as required. Qi2 can be supplemented by super-caps for standalone operations. Display updates by AI can void, advertise, or display messages to the card.

IoT is the secure communication medium within the retailer's premises, which additionally offers more device integration, i.e. cameras to take snap shots of voided transactions or alerts that are reported from the user's card or reader.

IoT can be combined in-store with the purchased products to instantly detect each purchase price and add the total sale value, immediately checking the cash register entry and confirming the correct input.

Cameras over the IoT network can use AI to confirm the purchased items in real time and send alerts if cash register variations or theft occurs. Camera images are deciphered by the AI network to identify the brand, value, and number of items etc.

AI cameras can be used to extract the card digital photo and compare biometrics with facial recognition techniques for security or preferred customer rewards etc.

AI-IoT techniques can be used to track the card user in the premises and identify possible theft scenarios by using mathematical, statistical, historical algorithms.

IoT can be used in retailer locations to create personalized marketing concepts and messages that have sales in their vicinity or discounts based on their store status.

Retailers will control the smart credentials IoT network, this is a substantial benefit to retailers and enables enormous scope with additional sales and security benefits. Today's payment readers are self-contained and not available for the retailer to adapt to their business. Banks and card issuers control the current payment terminals and transaction fees, therefore opening this technology to the retailer and adding AI has far-reaching operational, sales, marketing, and security benefits.

IoT transmission allows third-party data collection, integrating cameras and other dynamic displays. The ability to track Smart credentials cards within the premises, monitor their movement, direction, length of stay, number of entries and associate with the user profile, offers a totally unique perspective and understanding. AI camera image digitization and dissemination offers real-time determination of the purchased items and their movement around the facility and payment calculations.

Smart credentials AI App will also configure larger E-INK displays for a variety of purposes. The displays will have unique ID's, which confirms their size and pixelation requirements, plus advertising parameters, therefore a comprehensive solution for in-house displays, wall mounts, pictures, digital registration, or conformance documentation that is required in a licensed office or for diversity of practitioners.

In-store IoT networks allow the retailer to combine technology and communications together, offering enormous real-time updates to displays for a variety of purposes. The Smart credentials dynamic display card contains IoT, which offers full integration and history, personalized displays, and tracking. Bluetooth BLE adds to the trackability of smart credentials, via in-range mobile phones and Bluetooth transceivers.

Smart credentials can be used in automobiles, human operated equipment, and high-value devices for tracking. Engineering overhaul, parts replacement, or product use-by dates, plus inventory, all monitored and communicated by IoT.

An open or unsecure door can be determined through AI, and IoT offers more communication pathways for understanding the status of environments. IoT devices, such as smart door access controls are easily configured and can connect directly to the internet or connect over Bluetooth to mobile phone applications. These devices, along with IoT sensors, can monitor the status of physical/logical environments and provide real-time data for intelligent asset monitoring solutions, such as AI.

AI can process this data to determine whether a door is open or closed, for example, by analysing the sensor data from a smart doorbell camera. By connecting all these devices and data points, IoT creates a broader ecosystem that allows for better monitoring and control of various aspects of our environments. AI-POWER can essentially operate stand-alone and as the sole user interface.

The combined inputs from IoT devices and smart credentials allow for specific responses and logical AI analysis, making the management of environments more efficient and secure.

Firewalls are also used to inspect incoming and outgoing traffic from these IoT devices to ensure that security risks are identified and blocked, whether through physical hardware or digital software.

In summary, AI and IoT together offer enhanced options for monitoring and controlling the status of physical environments, such as determining if a door is open, while ensuring the security of the connected devices.

Smart credential's IoT connected multi-purpose applications can be incorporated into autonomous vehicles that add several layers of capability and protection. The ability for IoT smart credentials with processing capability can detect location, distance, height and heading from peripheral inputs. When combining camera images of ground and sky, visual or pre-recorded images can be used to follow set paths or identify correct paths, like modern human VFR (Visual Flight Rules) determinations and calculations of position and direction, which are human formulated. Technology can use various inputs and take advantage of multiple autonomous vehicles with IoT, IR, laser or RF to interrogate or check each other, verify location, path and mission, plus determine if blocking attacks are conducted, thereby deferring to each other, changing frequency, transferring urgent messaging via secure encryption and multiple communications channels, predominantly using IoT that enables higher security and transfers speeds, plus a single controller that can quickly transfer control if lost or damaged. IoT-connected devices have enormous advantages for security, defence against blocking or interference, multi vehicle control handover, intelligence gathering and decision-making. AI or partial AI-PORTAL intelligence act from program commands that are pre-determined and are resultant actions of various external interference or peripheral inputs that ensure continuation of the pre-defined mission.

IoT transmitters and receivers can be optimised and significantly extended with multi-units combining. Combined IoT units have far greater range, better coordination, and decision-making, plus quickly rearrange if any single or multiple units are lost. Camera Images combine well with IoT to determine location, direction, mission identification-either visually or from a static IoT transmitter placed at the desired destination. IoT combined with AI-POWERED information can autonomously complete the mission or combine with user commands to create a powerful drone capability.

Military applications include attaching the smart credentials to vehicles, equipment, drones, autonomous systems to enhance the network, communications security, or identity. Smart credentials with displays can be initialized in groups for self-contained network applications. A group of drones with individual smart credentials on each drone can communicate with each other in code Hopping rf transmission that inhibits external interference or blocking. All the drones utilise IoT techniques that ensure continuous operation if one or more of the drones are destroyed or removed from the network. Smart credentials are initialised by smartphones or mobile devices and each smart credential attaches to each drone.

The Smart credentials monitor GPS signals and GPS coordinates to ensure any attack or interference is blocked or quickly restarted with original data. The smart credentials are a low-cost addition to the autonomous vehicle that enhances network security and defence against attack scenarios. The relationship between mobile device and smart credentials enables a secure alliance with a self-contained low-cost intelligent coexistence system. The smart credential can monitor the status of all inputs and parameters of the mission.

The IoT network capabilities ensure all drones stay together within pre-determined distances from each other. The GPS coordinates are programmed into the smart credentials from the smartphone. Therefore, all devices will have a common destination and travel together with secure IoT networking. Additionally, multiple targets can be initialized and the IoT network determines that one, two, or more drone's breakaway to attack each of the pre-configured destinations as they continue along their path.

GPS system may also be supplemented by smart credentials located at the desired target or multiple target sites. The locating smart credentials send a constant signal in the direction of the approaching drones and identifies itself as the target. The ability to locate a smart credential, turned on or activated and placed at a target location ensures a totally autonomous solution to improve targeting success.

The solution afforded by integrating IoT networks has substantially greater rf frequency hopping defence options and the ability to control remote vehicles without high powered GPS or other satellite systems that can easily be blocked or interrupted. IoT networking is smarter, it can operate with thousands of vehicles over long distances on the ground or in the air and contain multiple task attack scenarios.

Smart credentials have an unlimited application adaptation capability, are low cost and setup or initialized by a smartphone or mobile device in any required configuration. The E-INK dynamic display allows determination of the setup parameters and is quickly identified visually or by electronic communication interfaces from other mobile devices running the smart credentials App. All required information is initialized at inception, plus the encryption keys and unique IDs loaded into each smart credential, is also incorporated within the security algorithm. Breaking any singular algorithm will only break one device whilst leaving the others operating normally.

Smart credentials can be grouped together with Master Key base encryption algorithms or separately with individual ID algorithms, depending on the requirement. Therefore, a single smartphone can initialize thousands of devices to be grouped or networked together. Both the smartphone and smart credentials unique IDs are used in the algorithms in each case. The security, flexibility, recoverability, defend ability, and autonomous nature of IoT is exceptional. Biometrics can be utilised to enhance security, plus unique identifiers and other security features added or adjusted to suit the requirements.

Smart credentials also enable packages or product deliveries to be coordinated and managed in conjunction with GPS coordinates or from received smart credentials transmission information. The ability to integrate low-cost secure networked smart credentials in an automation delivery or attack scenario creates greater security and more intelligent decisions throughout the flight or vehicle track. For instance, a product delivery service provider can load several packages in an Autonomous vehicle and the smart credentials determines drop location of each package based on pre-defined criteria, programmed, or initialized from a common smartphone or mobile device.

Airlines can use VFR, Visual Flight Recognition, for navigation purposes. Therefore, it is logical to assume autonomous Smart credentials can use camera, laser, IR or RF communications to navigate outside the normal GPS grid, or in conjunction with Internet/GPS. Autonomous vehicles require multiple input sources to ensure successful completion of the mission. Therefore, it is logical that a camera image can be used for navigation or precise pinpointing of a moving vehicle. The camera image can be compared with internal memory images, conducting a comparison technique, like retina, face comparison techniques. The real-time image can be compared to a stored image, or a stored path. The path can be initially conducted and retained in memory, then transferred to a second device that can follow the path precisely. Using swarm autonomous devices allows each real-time camera image comparison to determine precise location information or vehicle identification parameters, or multi mission targets, in conjunction with AI. Similarly, a path can be traversed or flown, and the visual data recorded, perhaps with height information and time of year etc. The information is recorded and used by secondary devices, that can mimic the path by visual image comparison techniques. It may also be advantageous to use other input sources, GPS etc., to gain closer proximity to the target, and then transfer final control to visual references, partially or solely.

The Smart Credential is simply attached to swarm devices and has a display, e-ink or other medium. The Smart credentials is battery operated and has long battery life due to its IoT, Bluetooth, USB etc., all having low power operating specifications. The Smart credentials device can be placed on the vehicle or drone and programmed with operational requirements by a mobile device over Bluetooth, including the display. This initialisation programming scenario allows swarm devices to communicate over a pre-determined encryption algorithm and the stored data information is input into each device to perfectly match the mission objectives or multiple targets, the path or strategy of travel, pre-defined path visual references or how to combine with other navigational inputs. The Smart credentials device becomes the controller of each attached swarm unit or vehicle and has the control parameters and mission objectives pre-encoded. Following successful downloading of data, the Smart credentials display reflects the vehicles readiness to operate. Any swarm device removed from the network has no detrimental effect on the remaining devices continued operation.

The secure mechanisms to issue, distribute, authenticate, and update Smart credentials can be conducted by the Issuer with the assistance of QR Codes.

The mechanics for implementation of secure smart user credentials can be conducted online remotely or in person. In all cases, QR codes and the unique credential manufacturing ID are both utilised with encryption techniques to ensure non replay, update capable, authenticated, one only-non copy.

Firstly, the Issuer purchases the smart credentials and allocates to their user base, each unique credential ID generating a unique QR Code. This is achieved by encryption techniques and an Issuer data encryption key, therefore maintaining control, management, and updates of the user database. Once the encryption process is conducted, the smart credential unique manufacturing ID is not needed to be disclosed in clear text, ever again. A pseudo-ID code could be generated and disclosed in place of the actual manufacturing ID, via encryption techniques. Therefore, attacks against the encryption process are much more defensible.

The smart user credential could also require biometrics identification prior to displaying or communicating the certificates, licenses, registrations, health, or secure personal information. This could also combine with 2 or 3 factor authentication as the environment, mobile devices etc. are known.

Sequence of events; license or registrations documents are issued to the owner with a QR Code. The QR Code was previously generated with smart credential manufacturing ID and selected encryption keys. The QR Code is sent to the owner who scans the Code into the smart secure credential. The QR Code also contains website information for registering receipt and authenticity of the owner. The secure smart credential confirms its manufacturing ID seamlessly during this process. Additionally, biometrics may be required to enter this logical/virtual section of the smart credential's user selection options.

When the QR Code is accepted and response generated, the authentication process is complete. Information pertinent to the owner is available online via the same QR Code and payment details are also updated and used for automatic payments. Thereafter, the process automatically continues.

Nonpayment by due dates will avoid expiry, which could enable further warnings or cancellation. The smart credential could then stop the display of the license or registrations, enabling the policing tasks to operate online or offline.

The above process allows digitisation of licenses and registrations with enormous gains for Issuers, such as identification of the owner, payments automation and real-time determination of all aspects. This process could also be adapted to credentials in vehicles, airlines, health certificates as promoted by WHO, passports, boarding passes, cashcards, payments, permits, gun groups, government and military, memberships, retailer networks, malls, corporates, and any global corporate institution. Any individual requirements not being met, will send warnings, deny access or restrict operation. Blockchain principles add significant strength to the authenticity of data and archived history.

AI-POWERED oversight in this system enables fast determination of authenticity, duplications, attempts to avoid payments or commit fraud. AI-POWER establishes assistance to Issuers in real-time and with exceptional processing speed. AI-POWERED Cloud interfaces are available on the smart secure device or separately under control of the Issuer. Digitisation of the process is an essential first step.

The digitisation of certificates, licenses, passports bring enormous benefits to Issuers and creates automated processes for payments and due dates. All information regarding individuals license, restriction, medical and company test results are accessible from an AI controlled facility that can grade each pilot or any specialist person or platform. The coordination of the user and vehicle parameters can also combine to enhance safety and certainty. The QR Code could also contain payment information that allows the owner or user to pay simultaneously. Eventually, documents posted to the owner or user would cease and the entire process conducted digitally online or in person.

Tracking information is available, depending on the configuration of the smart credentials. Tracking information could detect unlicensed vehicles digitally and movement controls implemented technologically. The process ensures movement routing and timelines can be effectively selected based on data and with AI assistance. Licenses and vehicle registrations are coordinated, location, speed, and payments made over the same network. Policing is made easy and can operate from mobile phone towers, as in ASEAN Countries, where manpower is the sole avenue of policing but totally ineffective.

The future will require digitisation of manual processes to gain the valuable assistance that AI-POWER affords. The above process can be accomplished seamlessly and progressively, with a greater awareness of user conformity and most assuredly will increase revenues.

Licenses for aircraft, light and heavy duty automotive, specialist or large mining, military, land and sea related equipment all require specialist licenses and endorsements, plus Health and other conditions, such as eyeglasses etc. These licenses can sometimes contain several conditions, certifications, Health checks, eyesight checks, age, region of operation, plus validity in case of expiration or cancellation.

Additionally, the equipment being driven or controlled has more requirements, such as type certificates, registration payment, insurance payment, class certificates, routine servicing completion based on hours used or annually. Therefore, the total requirement for licenses varies by region and by category, and in some instances, it is significantly detailed and difficult to determine.

The aircraft, ship or vehicle also contains a hidden credential, which has conditions that must be met before operation, these conditions can be compared with the user ID credential to determine if the user meets the minimum requirements. This determination is conducted seamlessly and can generate alarms or warnings if matching criteria is missing. Alerts can be sent by IoT, Wi-Fi or data connection to the relevant authorities. Interaction with burglar alarm systems can better coordinate alerts processes.

There are significant security and cost benefits available when user credentials can be authenticated digitally, and alerts transmitted in real time. Insurance cost reductions etc. may also contribute to financial advantages alongside security enhancements. This technology integration offers substantial benefits, not only that aircraft or specialist vehicles are being controlled by fully licensed and certified individuals. Primarily, the operational costs for safety and security are mitigated through the replacement of tasks by AI or autonomous technology, whilst enhancing the overall performance.

AI-POWERED integration of the above system adds an important layered addition and improves the autonomy, processing speed and decision-making components. AI-POWERED techniques are added to quickly identify the correlation between license holder and equipment being operated. Both the operator and equipment require confirmation of authenticity, service history, certifications, registration, insurance, conformity of specifications, time of day restrictions, total hours of equipment operation between services, total continuous work hours of the operator, health, medical checks and certifications, proof of operator identity—biometrics or multiple encryption device comparisons.

Smart credentials have multiple display and control options. The ability to match with encrypted service providers, such as WHO, allows display of Health Certificates. Generally, the display of information for each requirement, such as licenses, passports, boarding passes, cashcards and payment cards, photo ID etc., are selected by the user. The selection process can be simply swiping of the display to change from one page or application to another, or maybe voice controlled, biometrics activated or other options.

Smart credentials are a multi-use device that has several features and functions, it is a low cost, intelligent, portable security device and contains several firewalls against infiltration, modification or hacking attacks. The ability to securely accept and store certificates through encryption public/private keys creates a trusted, digital user device with the highest security standards.

Human temperature measurement is also available and may assist digital determination of health through IoT, Bluetooth or another communication medium. This pre-alert capability or indicator of health could be used as a warning or incentive for further tests and may also restrict access to certain areas until further health or security interventions are conducted. The display can be modified for security, expiry, health or other reasons and information is displayed or removed to indicate alert or attention.

Smart credentials can be utilised as a digital signature verification or sign off. When signing or verifying a transaction, specific operation or circumstance, the credential can require biometrics logon, simple touch screen or voice acceptance. The required use of a Smart credential creates a greater security solution to many daily tasks, including monetary transaction and identification online or offline. A school certificate, drivers or pilot license, passport, health data or any pertinent information regarding the user, controlled vehicle or product can be authenticated with certainty, including with blockchain.

Documents, Licenses and Certificates can be scanned into the Smart credentials smart credential and stored for display or later use. Documents, passwords, bank details, digital currency, investments, health information can all be scanned and stored in secure non-volatile memory. The information or data can be further secured by biometrics, which would be required to display the sensitive personal data.

Blockchain seed information creation can be commenced from the original document QR code.

Storing information in secure credentials with multi factor or biometrics security removes this sensitive data form mobile devices, where increasingly sophisticated attacks escalate. Documents in written form, certificates, licenses, passport information and images, passwords etc. are securely stored. In some instances, this data can be displayed on larger e-ink products for wall mounting, such as registrations of business, plaques, photos, paintings etc. are able to be displayed for a wider audience. Scanning documents, images, certificates can be conducted by one credential and sent to another IoT credential via Cloud connection, IoT, RF, Bluetooth, USB, or other mechanisms.

Changing from one image display or logical credential to another can be accomplished by touch screen, hand or face gestures, eye movements, voice commands or environmental automated actions that are pre-configured or AI generated. Each document storage location can be selected by touch screen or voice command. Each document or data can be stored under a voice name or digital heading for later retrieval. Bluetooth keyboards can additionally be used if device data modifications are required or additional security inputs etc.

Portable smart secure credentials can have cradle mounting options for powering and changing display with pre-selected images. The cradle mount could also incorporate IoT, along with controller functions, simultaneously recharging the battery. Battery state-of-charge display is a pre-configured display parameter, but indication of low battery state is a mandatory notification. When the credential is in the mounting cradle, the environment is discovered and pre-loaded logical or virtual input/output, plus displays are loaded or configured for continued operation. Local environment conditions are automatically available to be controlled, such as smart home etc. The display can be segregated into static or dynamic partitions, some can be updated, others not, this is specifically essential for advertising, logos, warnings, or alerts, when such information must be maintained on the display.

The Smart credentials integrating NFC, Bluetooth Low Energy (BLE), E-Ink and without power source (Battery-Less) is able to be powered by smartphones and transport, access, Qi or any wall mount readers. The ability to transition from NFC to Bluetooth BLE is accomplished by reading the NFC data output and communicating the same information back to the Bluetooth module.

This solution allows the transition from NFC to Bluetooth BLE, maintaining the same user information on both platforms and within a smart credential, without the requirement for a credential power source, battery-less. Thereafter, the Smart credentials can be operated by both NFC and Bluetooth technologies.

The ongoing advantages of Bluetooth BLE within the Smart credential is limitless due to the fast read/write capabilities of Bluetooth BLE. The Smart credential in this configuration enables further applications, essentially crossing new boundaries for combining the physical access component to logical or network access. Simultaneously the E-Ink display can be updated with pertinent information derived from the BLE operations, such as, value remaining, historical data collection and dissemination, plus higher security derived from multiple technology integration.

BLE and NFC are both powered by the smartphone or reading devices; therefore, these technologies combine to greater effect. QR codes can also be generated and displayed, creating a tri-technology combination for a variety of purposes. BLE reading devices can also operate with smartphones, creating a wider ecosystem. The reading devices can also include IoT, enabling a completely wireless backbone network.

The multi-technology card issuer or provider determines the encryption data key for both reader and credential, thereby customising the credential to their own infrastructure. BLE operations are much more secure and the whole system operation has not changed, only the Wall Reader and credential. BLE can thereby be used with the same user ID on multiple platforms and can still operate from NFC, or combination of more than one technology.

All references to Offline operation would generally involve blockchain integration, which essentially ensures process certainty of events through mathematical concepts. Therefore, combining AI and blockchain offers an alternative solution to online operations and removes the security weaknesses of Network IP addressable devices and passwords.

Biometrics and Blockchain generally combine to ensure certainty of the human identity in the blockchain process of events and therefore close the security loop in ascertaining authorisation and identity. Biometrics can be considered an integral feature of the system to engage security and identification within ‘proof of works’ or ‘proof of history’.

Blockchain also ensures the certification, registration, modification and maintenance of user operated vehicles and license holders. Additionally, blockchain concepts assist with aircraft type rating and VFR or IFR certification of pilots. Therefore, the ability to determine currency and authenticity of licenses, passports, boarding passes, security credentials etc., is vastly improved with blockchain integration and further enhanced with AI-POWERED platforms. The combination of AI and blockchain enable a connected IoT environment to provide unparalleled security levels with absolute user belief of the history of events. Blockchain provides a real and discernible event trail without need of a traditional online security platform, which is mostly reliant on passwords.

Indeed, the combination of Artificial Intelligence (AI) and blockchain technologies can offer significant security improvements, particularly in offline, IoT or disconnected environments.

AI can assist in identifying security threats, managing data, and automating various tasks, thereby enhancing the overall security posture of a system. On the other hand, blockchain technology is known for its robust security features, including encryption, decentralization, and immutability, which can significantly improve the security and trust in complex, multi-stakeholder environments.

This combination can be especially beneficial in offline capabilities, where the security and integrity of data are paramount. For instance, in the context of Central Bank Digital Currency (CBDC), the integration of these technologies can ensure secure and efficient transactions even in offline settings.

Today, Qi2 Wireless charging offers 15 W of power without the need for wires or connectors. In the future there is an expectation this will increase to 120 W and above. Qi2 contains magnetic orientation technology, which allows the transmitting and receiving devices to meet at the optimal physical charging position, based on the magnetic field's ability to fine-tune the position, thus creating maximum charge power transfer, and minimizing heat and other losses.

Similarly, the magnetic field could provide a holding force, either through-wall, through ceiling, or through any non-metallic materials, desktops, windows, dining tables, cabinets etc. The magnetic field could provide both orientation of transmitting and receiving devices, plus holding force.

Downlights in houses generally operate from 12 v and require a transformer to convert standard AC voltages to 12 VDC. The transformer is another point of possible failure, becomes very hot in some instances and has an additional dollar cost issue. Installing downlights in homes or buildings is an expensive and difficult exercise due to many technical, planning and installation aspects, plus are not easy to re-arrange if initially placed incorrectly or desired changes. The need to transform voltage for lighting technology, plus drill holes, normally requires professional help. The downlights, strip and/or led lights, plus similar technologies are low-voltage and operate between 1 W to 10 W.

Qi2 Wireless chargers operate today at 15 W, which is sufficient to power LED lights, whether the configuration of light is strip, downlights, camping, or external remote area lighting. There are many advantages of using Qi2 to power lights and other low-voltage devices.

Qi2 can also power an E-INK display of any size or simply change its image. Using the Wireless charger and mobile device to change the E-INK display requires the mobile device to have an App installed that is designed to communicate with the E-INK display, by Bluetooth BLE, NFC etc. The E-INK display (once changed or programmed from the mobile device) is then able to be hung or applied to any vertical location, wall, ceiling, door entry point without further need of power, operating for some years. Therefore, a user could initialize the display of an E-INK screen with data that is transferred from their smartphone to the display. This allows for the initialization of marketing materials, pricing goods in a mobile environment, at home or in the office. Signage, exit signs, nameplates, office notifications, building certificates, portable food stalls and a million applications can utilize an E-INK display, which is ultra-thin and programmable by the ubiquitous smartphone. Color options, image and word documents etc. offer enormous scope for diversity of usage.

Similarly, Qi2 recharge technology could be placed on the non-visible side of the ceiling, wall, mobile sales outlet, vehicle or beneath a dining table. The Qi2 recharge technology could be powered by mains supply or batteries, rechargeable or non-rechargeable. Ceiling lights with LED output operating at 3 W could be placed in any location to match the Qi2 magnet, which could be moved later for any purpose, to suit the user. Qi2 provides sufficient magnetic holding force without any holes through the ceiling or walls. The advantage of an ultra-thin LED ceiling light that Wirelessly attaches to a Qi2 Wireless charging unit, is that no direct contact or hole is required, movement thereafter is optional and simple. Similarly, on a dining table, the Qi2 Wireless charging unit with battery could be placed underneath the table. When the corresponding Qi2 receiver LED light is placed on top of the Qi2 charger, it immediately lights, and stops when removed.

The desktop or tabletop LED light with Wireless power input does not need any physical switch, because it is simply placed on the Qi2 locator position for operation and then held in place by the magnets. The Wireless charging technology transmitter and receiver allows more power and therefore more LED output light illumination, much stronger fan operation, etc., in comparison to battery operated devices. The Wireless charge solution also lends itself to incorporating Bluetooth BLE and IoT for control or variation of the operating setup, display, speed of fans etc.

Traditional candles offer an excellent light source and are portable in their usage and used in a very similar manner to the proposed Wireless LED light, which is powered from a non-visible Wireless charging source. Therefore, this description will show that a new lighting medium without wires, being powered wirelessly, creates a new dimension of applications in house, garage, campsite, external lighting, with an aesthetically pleasing minimalist/low-profile design, low cost and is flexible in light output colors. The Wireless receiver adaptor combines with any number of LED lights (strip lights), plus with the ability to be held in place by the Wireless charging device's magnets. Additionally, the Wireless charging device charges multiple devices, smartphones, earplugs, electronic watches etc., a truly multi-use, simple, safe, low cost, flexible, portable, and green solution. The Wireless receiver decides its power requirements and speed of charge.

The Wireless charging transmitters could incorporate Bluetooth BLE, IoT etc. A base-station Qi2 Wireless charger version could allow the smartphone to transform a Bluetooth BLE to IoT Protocol change, which allows the smartphone to control all the IoT devices in range. This IoT control capability allows the other Wireless charger transmitters to change color of their local Wireless receivers, turn on/off etc. The smartphone would need to download an App to perform these tasks.

The Wireless charging receiver could include a receptable that is capable of inserting LED lighting of any standard attachment size or profile design that creates a pleasing aesthetic design. The charging receiver receptacle receives charging power and transfers to the lights or commensurate technology via an appropriate connector, receptacle, or connection. Lights, fans, speakers, displays, notepads etc., can be interchanged because the Qi2 technology ensures all devices request their operational power needs and autonomously operate as designed.

Wireless charging units, whether Qi2 or any similar magnetic inductive technology, could also contain Bluetooth BLE or IoT technology. This allows the charging transmitted unit to change the receiver unit. The Wireless receiver unit could be any technology, including E-INK displays of any size and orientation. The ability to communicate with IoT over long distances and with security in-built, offers enormous capability to the system, plus interaction with any IoT platforms. IoT control options include remote operation; on/off, open/close, color or mood change or display change etc. Control changes of any aspect of the system could be initiated by IR sensors, movement detectors, cameras, or other security devices, possibly with AI integration or from initialized parameters.

Advertising can be integrated onto the displays in pre-configured and protected zones of the E-INK or commensurate display technology. Similarly, advertising can be integrated into the smartphone App., which is a requirement to initialize and manage the system. AI techniques could also be integrated into the devices or within the smartphone App., or both. AI can control the advertising transitions, change dates, payments, and other operational criteria in a seamless real-time manner.

Combining IoT connected devices in a ‘zone’ configuration allows the whole setting to be changed for mood or personal preferences. The whole environment could be changed to suit the user or owner, simply by detecting their mobile device or their smart credential. Similarly, this configuration could be adopted in shared offices, between individuals or for meetings etc.

IoT controls can connect to smart homes, financial payments, security systems, and add to the user experience by coordinating device integration. Prices, people movement, daily sales, advertising, messaging, logos, cameras, LED light displays, adjusting turning on or off, or flashing warning/alert signals for customer or operator attention, or for audit purposes. Cameras can be activated for split seconds or minutes, reducing power and data storage etc., whilst still grabbing the images.

Similarly, Barcode or QR codes could be integrated into the marketing price list, and the user could scan the image for further information. All displayed and adjusted remotely to the E-INK screen.

Personalized movement detection and zone/area configuration offers enormous scope, especially when the smartphone can convert its Bluetooth communications into IoT. This is achieved via smart credentials. Smartphones have Qi2 incorporated and can have an ISO (non-battery operated) smart credential attached to the rear purely by magnetic holding force, thereby increasing the depth by a minimal margin. Similarly, the smart credential is powered by the desktop Qi2 Wireless charger and may be applied to the Wireless charger whilst remaining attached to the back of the smartphone. Qi2 Wireless charge signals can charge multiple devices in parallel. Therefore, the desktop mounted smartphone-smart credentials are placed together on the Qi2 Wireless charging device. This combination allows IoT devices to have much greater operating distances, perhaps measured in km's. IoT devices are also transceivers and extend the range of IoT by their inclusion in the network.

An IoT network can be defined as a zone, when initializing all the devices on the network. The zone configuration information is input into the smartphone and includes an AI assistant to ensure the zone configuration is made more intuitive for the user. When a zone is configured, the next step is personalization of the shared space persona or mood for each individual or group of people.

Moods could also include temperature modification, music, lighting, wall hangings, signage, or any devices, whether incorporating IoT or power is applied by an IoT remote on/off switch. Device settings are all adjusted in the smartphone App with AI support and could be further adjusted with AI support or timed by pre-defined variations, i.e. day/night mode. Therefore, the zones and personalization of the devices, displays, lighting etc. are all controlled from the smart phone App and thereafter by AI, smart credentials, or smartphones from everyone can automatically recognize them and adjust as has been pre-programmed. IoT is a secure network that doesn't require IP addresses and WIFI connections, therefore is deemed more versatile and secure.

Motion or movement detectors can determine the presence of homeowners or intruders for different purposes, and both work simultaneously. Therefore, cameras and movement detectors first detect an individual and then use algorithms or peripheral devices, such as smartphone, smart credentials etc., to make determinations of ‘friend or foe’. AI can support the ability for smart home devices to operate as both personalized settings and detection of intruders.

Loyalty and membership cards can improve the customer experience and offer brand recognition, when combined with a dynamic display card. The card cost can be reduced by minimizing the technologies, relying on Bluetooth BLE as the main communication medium.

An in-store reader could transform BLE to IoT and use the loyalty customer's profile to adjust marketing and discounted products. The IoT network can be used to draw the attention of the customer to different locations, which are recognized through their shopping history.

Online shopping could request shoppers to use a code or their loyalty/membership number, thus combining online sales with in-store, increasing customer profile and marketing strengths of the retailer, plus allowing cross-marketing of the online and retail store discount offerings.

Membership smart credentials offer a display medium for the user to understand their membership details, expiry date, rewards, discounts etc., offer real and exciting benefits for the user. Smart membership credentials could simply be badged to an entry Bluetooth smart reader at the facility and certain information is available or downloaded to the smart credential, all in real-time and monitored by AI. Personalization of the experience in the membership facility and rewards associated with regular visits or spending patterns will ensure the valuable business effectiveness of using smart credentials in many different environments for many different purposes.

At a transient time for shoppers, it's critical for brands to be on point in their communication and delivery. And it's critical to be asking questions, listening to the consumer, and be prepared to change.

Smart credentials can include financial debit/credit and cashcard virtual cards and used internally or online, thereby creating an audit of expenditure and profile of preferred purchase types. The ability to use a multi-purpose smart credential for shopping, loyalty and membership rewards, which gives more personalized performance and offers a marketing experience, is a step into the future.

Smartphones will undoubtedly use more AI applications over time, particularly Generative AI to create content, images, videos, text, music, audio etc. E-INK devices are perfect for capturing this information and displaying on the rear of the smartphone, on walls and desktops. The ability to generate images alongside personalization data content is an enormous catch for technology enthusiasts, also for signage that creates unique images, marketing, and advertising etc.

An adjunct smart credential is the perfect hardware solution for storing Generative AI content, plus with personalization or referencing specific functions of the smart credential. For instance, a smart credential could operate as a badge ID, name plate, photo image display or a display that reflects the emotions of the user. The smart credentials could also be multi-function passkeys, bank accounts, door access devices, or decorative credentials for appending to luggage, purse or handbags, wallets.

The advantages of E-INK are many and varied, but when used as a smartphone adjunct, they become extremely powerful and are formidable security enhancing devices. Images can be downloaded and changed at will or on timed events, birthdays etc. Marketing, signage, and advertising companies could take advantage of the display medium and the personalization that individuals will enjoy.

Human emotions and moods are now discoverable by AI-SYSTEMS, therefore could adjust the image, color, mood, or reflective attitude of the user, voice prompts could also adjust the image settings. The ability of E-INK display devices to match the individual's mood, whether smiling, sad, crying etc. is a step to greater synergy of electronics to human nature. The environment can be matched with the occupants and E-INK, or other low powered displays are the perfect medium.

Battery-less credentials dominate the global market because they are cheap, easy to manufacture in volume, relatively easy to customize for larger corporations and perform their technology task requirements with adequacy. Additionally, it is cheaper to manufacture credentials without batteries and cheaper to ship, lower cost of shipping insurance, less human involvement when replacement or recharging of batteries is required. The advantage of battery-less credentials is many and varied, hence they dominate the global personal use technology spectrum.

Credentials without batteries continue to dominate global markets, which proves their preference, acceptance, and adoption into many different application sectors. With the growing appetite for more security and flexibility, the plastic ISO card is the ideal physical size credential that could entice users to upgrade. However, NFC power harvesting from wall-readers is limited, both by the one-way communications and weak security. A common solution to increasing the effectiveness of plastic cards is to insert a battery to accommodate additional technology. Examples of adding a battery are for biometrics authentication, an automotive keyfob and remote-control devices.

However, there are technologies today that deliver power from Wireless charging magnetic inductive circuits, which are increasing their power delivery and range of operation rapidly. Wireless charging as in Qi or Qi2 standard and other commercial standards are being sold in greater numbers. Wireless charging commences the ultimate technological goal of removing wires from the desktop entirely.

A technological solution is also afforded by Wireless Charging, in that, the circuits can be used to charge a plastic card that contains additional integrated technologies, in much greater capacity than previously available with NFC power harvesting techniques. This technology powering alternative will be explored and explained below.

Integrating biometrics, Bluetooth BLE, cameras, speakers, IoT, low-power displays, microphones into a standard ISO sized plastic card enclosure offers many and varied applications. Smartphones today with AI interface and incredible micro processing power are capable to initialize technology in other devices, especially by using the Bluetooth communications platform, due to its security and ubiquitous implementations, automotive, earphones, speakers etc. However, Bluetooth still has a range of operation limitations of around 10 meters and in some cases up to 100 meters. Therefore, IoT fulfills the gap of truly long range and secure communications with minimal operating power requirements and great versatility for private network functions, connecting many varied devices.

There is a potential solution to combine all these technologies and utilize the smartphone for initialization and management functions. This can be achieved by using Wireless charging circuits placed in doorways and other restricted or confined areas to power the smart credential, even if there are no batteries. This is accomplished by using super capacitors or commensurate technology that takes a fraction of time to charge and holds the charge over protracted periods. Super capacitors or super-caps are an ideal combination technology for Wireless charging circuits operating over longer distances because they require minimal charging power and offer incredibly fast charge rates.

Bluetooth BLE, E-INK, IoT, RF transmissions require short pulses of energy to operate, therefore can be an ideal technology partner with the super-caps and Wireless charging circuits, all combining to offer battery-less operation of ISO plastic cards with smart technologies combining. E-INK displays require only a pulsed power input to change display, thereafter the display remains visible without further power input for many years.

The combining of the unique qualities of these technologies, plus intelligent inter-relationship and power management and an initialization platform with the smartphone and AI, offer a unique and unparalleled solution to greater usage and effectiveness of the smart credential, whether in plastic card ISO physical size, or larger display sizes or variations for automotive etc., there is a methodology that can change the technological landscape of user credentials, available today.

Security can be seamlessly adapted to buildings, hotel entry doors, gateways, restricted areas, zones or meeting rooms, where Wireless charging circuits can be placed in the perimeters of the entry point and propagated to the user smart credential, offering power and discoverability from the user credential. Similarly, IoT wearable devices, watches, ID badges, etc., can incorporate the super-caps and use Wireless charging technology in the same way.

Retailers and Corporates can use the super-caps powering option in their membership or loyalty cards. When a user enters their facility, they are immediately identified, and camera images can be additionally deployed for photographic authentication or audit purposes. Initiating an IoT transmission as soon as the super-caps are powered, offers seamless identification, movement, tracking and personalized marketing. Similarly, smart credentials can be badged at payment terminals, door readers, access entry points for varied reasons, this action also powers the super-caps and offers immediate IoT communications. Additionally, changes to the E-INK display medium and an historical audit trail of the user, possibly also with biometrics incorporated. The E-INK display can then indicate to other users the status of the wearer, security zone allocation, last entry point with their photo ID and other data as desired by the issuer.

Inductive charging techniques can be deployed safely in open view or hidden, to ensure user credentials are identified by first powering the smart credentials' super-caps. Super-caps can be charged within the period of entering. The output generated by the Wireless charging barriers or an IoT reading device, is the same. Powering the super-caps thereby powers the associated technology, IoT etc. The Wireless charging circuit can be hidden within the doorway for more security and pleasing aesthetics or that are openly and plainly shown to the user.

Barrier detection of user credentials and powering of the super-caps is not costly, because the barriers only require a mains power input, no other communication is required, as the smart credential offers the communications via its IoT or Bluetooth interfaces. The barriers also introduce people counting and can detect when tailgating (people following closely behind another person), by using cameras and motion detectors to count people etc. Therefore, introducing barriers, whether hidden or in the open, offer several important security and personal mapping profiles. The Wireless charging circuit can be installed externally on the locked entry door or zone and create an entry verification of the individuals, prior to gaining access. Therefore, no external wall readers are required and simply by using IoT long range communications, access can seamlessly be gained.

This system could be deployed in hotels etc. and the security incorporated into the IoT communications, whereby each new hotel guest updates the entry algorithm to accommodate their stay, removing the previous guest's right of entry. The magnetic inductive Wireless charging circuit could be implemented in conjunction with motion detectors, to reduce power consumption.

Seamless access identification is a preferred method of security for accessing buildings, areas, zones, or open areas, such as conferences, meeting areas, airports etc. IoT allows combinations of technology to work together for many and varied purposes, including security, movement, tracking, marketing etc. Magnetic Inductive techniques will continue to improve, as will super-caps performance and will give greater acceptance and offer seamless entry experience, whilst gaining a greater profile and understanding of the guests, entrants, employees, conference attendees etc.

Qi2 Wireless Charger with E-INK Display, IoT & Bluetooth:

INPUTS: NFC 125 KHz; Contactless Smart Card 13.56 MHz; Bluetooth BLE; Cash-Card 13.56 MHz, Octopus, Oyster etc.; Camera; Voice Microphone; AI Assistant.

OUTPUTS: E-INK or similar display; Qi, Qi2, or similar Magnetic Inductive signal; IoT; RF Encrypted Rolling Code; Wiegand over RF or IoT; Bluetooth BLE; Wi-Fi; IR Sensor and TV Controller.

Burglar Alarm system on/off.

Air Conditioner interface with temperature control.

Mood/Lighting control, which could be user selected or timed.

Message display, events, calendar, and urgent reminders.

Speakers

Timed Alerts, notifications for friends or family.

Electricity control monitoring, no movement=no lights.

Night Light, E-INK backlight, torch functions.

The portable Wireless Charger is a travel accessory with image setup from the user's mobile phone by NFC or Bluetooth. The ability to accept multiple interface technologies and convert to long range or more secure outputs, enables an extremely powerful and versatile solution.

Driving home and opening the garage or turning on external or internal lights, plus activating any connected devices, burglar alarm system on/off, air conditioning turns on/off, door access control on/off plus many more, enable a truly unique and powerful consumer product.

Charge your mobile phone, convert Bluetooth to other communication formats, display selected images, logos, advertising or pictures, clock images and set alarms. Combine with AI to operate a closed look security system, with camera and motion detectors, storage of images and audit trail.

Use the camera as a mirror, simply by user selection or moving close to the unit.

Allow the unit to move and follow the user device, smartphone, or smart credential, thereby always offering premium viewing angle of the display.

When travelling, use the unit to secure your connected luggage or valuables by adding a luggage IoT tag to anything that needs to remain in secure distance of the unit. Use the image display as a clock with many clock face images that are downloaded from the smartphone by Bluetooth, plus set the alarm—all from the smartphone AI App.

The smartphone accepts voice inputs and transfers these messages via Bluetooth to the Wireless charger, even under AI control, which adds intelligence with all initialization selections and screen image displays.

Existing NFC and Contactless smart cards are usable because the data is appended to the RF communications either directly or under further encryption processes, then received by the receiving device, decrypted if necessary and applied to the system or platform in the same way. Therefore, access control systems can maintain their same user cards and credentials, only the reader changes to gain greater communications security, speed, and multi-purposes device interactions, especially on an IoT network.

Use your existing NFC card to enter facilities or make payments. The Wireless Charger with E-INK and IoT creates a secure Wireless Network and provides protocol conversion options, plus personal use configurations with AI Assistant.

A truly unique and versatile E-INK display product, all features and input/outputs are configured by the smartphone. The functions can be minimalist with one or two protocols, or comprehensive with several input outputs for a more sophisticated multi-purpose use case.

Advertising or Logo in secure areas of the E-INK display ensures that the image is configured as per the manufacturer or distributor. Certain areas or quadrants on the display are non-changeable.

AI Assistant can be utilized both in the smartphone and from the Wireless Charging product, where Wi-Fi connections may be required to create far greater AI Assistant functionality. AI Assistant is flexible in its use, being especially important in setting the parameters of use.

Standalone operation with batteries or connected to mains electricity, offers travelers far greater convenience, portability, and in-car applications. A perfect travel companion because most electronic devices are now Wirelessly Charged.

Night Light and display backlighting are available and selectable. Torch functions from internal batteries and becomes a very important companion device.

Time & Attendance allows the clock-on/clock-off information for everyone to be sent via IoT or BLE to the computer or smartphone, saving countless hours viewing and collating timecards. Additionally, the E-INK display would have a standalone option to view all individuals' attendances.

AI Assistant can identify the location as being in-car, travelling interstate or overseas, at home relaxing or determining individuals' moods by facial determinations. Therefore, AI Assistant has the role of performing tasks based on environment and whether the card or credential badged to the NFC, IoT or BLE interface is most likely to be used. Perhaps, driving home after work and entering the garage area, the AI Assistant can determine the requirement for the garage to open and lighting or temperature controls to be activated. Additionally, the AI Assistant can look at historical selections and determine common usage or repetitive usage patterns.

Any IoT, NFC, Contactless Smart Card or BLE wall or desktop reader will require a communication receiver. Generally, the communication receiver will operate by IoT to allow long distance and secure transmission. The receiver in this instance is basically a Qi2 Wireless Charger with an IoT to BLE protocol conversion and therefore allows the information to be downloaded into a smartphone or computer by the BLE interface. The Wireless Charger with IoT and connection to computers or smartphones allows audit data and additionally offers controllability of more IoT devices, such as desktop name plates, office entry signs, exit signs and other requirements for commercial or private use.

The consumables for an IoT ecosystem need to be configured and initialized to communicate to each node and it is envisioned that a website of consumables is available with many and varied IoT devices that perform in an ecosystem of diversity of device connections, security and convenience.

A T&A Time and Attendance IoT/BLE/NFC Reader will also utilize the contactless smart credential or smartphone as Log-in/Log-Out. Using a contactless smart credential or smartphone enables a form of authentication to take place during the badging process. The contactless smart credential and smartphone both can store a digital image of the user. The Reader contains a camera, both for biometric authentication and for historical audit trail. The output signal can contain time in and time out, plus the digital facial image and results of any biometrics authentication that had taken place. This system automates the process of access and T&A, whilst also ensuring that a single user cannot badge multiple individuals subversively.

Plastic cards normally incorporated NFC technology, whether at 125 KHz or more recently with 13.56 MHz Magnetic Inductive transmission frequency. Contactless smart cards, such as Mifare, operate on the 13.56 MHz frequency and offer unique memory options, encrypted under multiple data keys and with various partitions with increasing storage capacity.

An example is the Hong Kong Octopus cashcard, which operates at 13.56 MHz NFC and is accommodated within the smartphone architecture. However, these cards generally require no signature, no security or authentication of the user. This technology is operated globally under different card issuers, Oyster card in UK etc.

This document describes how to simplify the security of cashcards by using simple techniques and incorporating Qi2 Wireless Charge technology, which creates a sufficient power resource for more sophisticated features and functions within a standard ISO plastic card without battery.

Online transactions can be conducted by using the Octopus App., thereby identifying the user within the App. However, when using the Octopus Card, the transactions are generally limited to HK$3,000, which is a limitation that is imposed because there is no security inherent in a Wireless magnetic inductive transaction, which requires only the swiping of the card to the reader.

Qi2 technology offers more power resources and therefore greater capacity to operate additional technology within the ISO plastic card limitations. This document identifies several stages for increasing card or credential technology, including introducing biometrics fingerprint identification by integrating a module within the card itself. However, this advanced security also complicates the operational complexities of placing a finger on the card during or prior to operation.

There is an intermediate security step that is far less costly and far less complex. This step is the addition of Bluetooth BLE within the ISO plastic card, which will combine with the NFC portion of the card, during and prior to the transaction.

Incorporating both NFC and Bluetooth BLE allows the same card to continue to operate at all existing NFC readers and payment terminals without any changes.

The advantage of Bluetooth BLE is its faster communication speed, more secure transmissions and the ability to incorporate multiple layers of encryption techniques between card and reader. Bluetooth BLE and NFC coexistence in an ISO plastic card enclosure and with Qi2 Wireless Charge is an enormous step forward, with little cost, but with considerable security and capability.

An NFC card reader takes information from the card and transfers it to a decision-making platform, whether this is secure access or payments or otherwise. NFC 125 KHz requires negligible power from the reader, whereas Bluetooth BLE requires more. Also, Bluetooth operates from higher frequencies and is trending towards 50 MHz in some instances. Therefore, Bluetooth BLE can easily transfer digital images for biometrics comparison purposes, all within fractions of a second.

Bluetooth BLE is a far better communication medium than standard NFC, however the current infrastructure is so prevalent, that replacement en-masse is deemed impractical. Therefore, a transitionary phase is required.

The transition envisioned in this description is to first incorporate Bluetooth BLE in the standard ISO card and accept that readers in the future will migrate to Qi or Qi2 standards or similar technology.

In the interim phases of the transformation of payment systems in situ, NFC will operate as normal and the payment floor limit could be associated with this older more insecure transmission medium. When Bluetooth/NFC combination readers are deployed, the expectation of greater security allows payment floor limits to increase.

Every new ISO card with the combination of NFC and Bluetooth BLE allows the card to compare three unique ID's, which is further secured by encryption using these unique IDs in the mathematical algorithm: Card unique manufacturers ID, NFC unique number, and Bluetooth BLE unique identifier. Whether for access or payment, every NFC transaction currently uses the card's unique number. Therefore, we combine many unique identifiers together with both NFC and Bluetooth coexistence in a plastic ISO card.

The above ensures a unique ISO card for every user and copying the card is extremely difficult due to many features of the hardware and combination of encryption mixing/matching the unique ID's. Therefore, we can make an extremely unique ISO card with little additional cost.

The Bluetooth BLE and NFC combination card can be issued to users by mail or post. Once the user receives the card, they download an App on their smartphone to initialize the card. If the card is to perform higher floor limit payments, then a digital image is required to be downloaded into the ISO card, which is supported by an AI Assistant. Once the card is loaded with the owner's digital image, then it is possible to conduct biometrics authentication, prior to any payment or access being granted. This phased security step then opens far greater flexibility and usage of the ISO card.

The combination card still works the same in all existing NFC terminals and readers.

As the card readers are upgraded, then much more certainty is gained from the user card and biometrics is used for authentication and for historical audit of the payments or access.

It is possible that the manufacturer of such ISO cashcards or transport cards could determine a transaction fee, whenever the card is used with the technology, such as with higher floor limits.

In one embodiment of the system of the present disclosure, the system includes a credential device reader with Qi2, USB, Wi-Fi, Camera, Bluetooth BLE, IoT and E-INK display. The credential device includes an ISO card or ISO card-sized device with Bluetooth BLE and NFC, including a contactless smart card, 13.56 MHz and 125 KHz combinations, with optional IoT. The credential device may include a battery powered card, where the battery is charged by Qi2 and have super capacitors for immediate power drawing and storage. The credential device reader contains Qi2 functionality and batteries, plus a USB power input connection, plus USB communications to PC functionality, plus a wireless Qi2 charger and IoT communications.

When connected with a PC, the credential device reader communicates with the PC interface for additional security and OTP generation. The credential device reader also allows the user's smartphone to be combined, offering charge power, plus external IoT long range communications. The smartphone can communicate to the PC by Bluetooth, USB or via IoT, conversion conducted inside the credential device reader.

When used as access control on a wall mount entry scenario, the updated Bluetooth credential device card can contain a digital image or biometric data, which can be used as biometric data identification of the user at the point of entry or seamlessly by IoT around the building.

Additionally, or independently, the credential device Bluetooth card can conduct certain internal checking actions to give greater certainty of authenticity (not a copy card), both of the card and user. The credential device card could also detect Bluetooth from the user's smartphone, thereby conducting a multi-hardware security (in-range) verification.

The credential device reader is configured by the operator to accept, request, or disregard the digital image of the user over the Bluetooth interface. The digital image can authenticate the user at entry. Additionally, or independently, the digital image can be displayed on the E-INK display with the user nickname or zone allocation.

The credential device readers and credentials are configured by the smartphone, offering complete control over the functions utilized or selected in all credential products, including IoT connected devices, such as cameras, tracking tags or e-ink displays.

When the user image and access information are displayed on the credential device reader, a secondary camera may be operated to take an image of the entry credential device reader display. The actual image of the user by the credential device reader camera is also sent for comparison purposes, either to a computer or remote security controller. The credential device user card image and the displayed image on the credential device reader are both sent via IoT or other communication mediums to a comparison computer. This external security identification system enables users to move fast through the entry point. The images are used externally for comparison or historical audit purposes, as desired or required by the operators, therefore complete control over the requirements of entry with all credential device products. The smartphone with AI support is the initializing platform and is used to personalize the products for the users' or operators' benefits, with updates ongoing or as required.

The smartphone App with AI Assistant also determines the technology in-range and the state of operation, for instance, the NFC card could have default encryption keys and be ready for programming, or there could be restrictions with encryption keys that deny further programming without the correct encryption keys. Al and the smartphone App determine the state of operation or status of the products requiring to be communicated or initialized. Similarly, AI determines the size and character of the image displays, for E-INK or other display technology (LED, LCD, Laser) mediums connected to the TC IoT ecosystem. The IoT interface of the credential device reader also takes the user card ID, by NFC or Bluetooth and converts it to IoT communications that is transmitted to the credential device controller, which is connected to the security system by Wiegand wires or another connection. The controller can also offer more functions for the user, such as historical image audits, further IoT connections or data that is pertinent to entry times or entry anomalies, dual cards, invalid ID's, restricted access cards, cleaners, contractors etc.

Therefore, the credential device reader and the controller are strong and customizable security devices, plus with biometrics authentication, plus an IoT interface to communicate with other devices, autonomously and distinctly from the incumbent security system.

The simplest user card upgrade is achieved by adding Bluetooth BLE, and NFC combinations, not necessarily having a display. The NFC and Bluetooth BLE can be programmed with the same Wiegand or entry information, and older readers with NFC only, still operate satisfactorily, whilst readers in more secure areas of the facility will require Bluetooth BLE or possibly biometrics identification, therefore the credential device reader options are simple, seamless, and customizable for every scenario.

The credential device reader is a multi-functional device and is configured by a smartphone over a Bluetooth, USB or NFC interface, the smartphone can be charged simultaneously. The credential device reader can be used in smart home applications and enables IoT or Bluetooth control to many devices, IoT tags and IoT wearables etc.

The credential device reader can accommodate rechargeable or non-rechargeable batteries and powered from the USB or the Qi2 interface. The credential device power control system detects power input availability and determines charge rates and charge parameters.

The credential device reader can display images in combination with access data, massages, notifications, advertising etc.

The credential device products can message each other in secure encrypted format, therefore offer a highly secure and flexible secure communication system.

AI is used on the Smartphone to configure the credential device reader and Bluetooth, NFC cards, programming the operating parameters and data, digital images and logos etc.

The credential device reader creates an IoT ecosystem, whilst gaining greater clarity of the user at entry and online to computer network or from user payments. The credential device reader is programmable for a variety of tasks and applications.

The credential device reader, controller and credentials can be adapted to any environment, cashcard transportation, bank debit and credit card payments, access control, tracking or remote-control systems, identification as a license or passport, health care information in secure non-volatile storage, loyalty, memberships etc.

In an embodiment, a security access system is provided, including:

a security access credential device;

a credential device reader; and

a controller controlling access to a Wiegand-compatible security access validation system; and

the security access credential device being configured for bi-directional wireless communication with the credential device reader to provide credential data to the credential device reader, the security access credential device being assigned a unique identifier;

the credential device reader being wirelessly connected to the controller and being configured for bi-directional wireless communication with the controller to provide received credential data to the controller;

the controller being in communication with the security access validation system and arranged to convert the received credential data encapsulated in a wireless communications protocol of a wireless communication link between the credential device reader and the controller to a Wiegand-compatible clear text communications protocol of a communications link between the controller and the security access validation system;

the security access validation system processing the received credential data and providing Weigand-compatible clear text response data to the controller indicative of a validation of the received credential data or a declination of the received credential data,

where the controller, on receiving the Weigand-compatible clear text response data, converts said Weigand-compatible clear text response data to the wireless communications protocol of the wireless communication link between the credential device reader and the controller and thereby initiates an action and/or conveys the converted response data to any one or more of the credential device reader, the security access credential device, a device associated with the credential device reader, or a third party device or system.

In an embodiment, a system to facilitate a transaction between a credential device and a service provider system is provided, the system including:

the credential device;

a credential device reader;

a controller controlling access to the service provider system; and

the service provider system;

the credential device being configured for bi-directional wireless communication with the credential device reader to provide credential data to the credential device reader;

the credential device reader being wirelessly connected to the controller and being configured for bi-directional wireless communication with the controller to provide received credential data to the controller;

the controller being in communication with the service provider system and arranged to convert the received credential data encapsulated in a wireless communications protocol of the wireless communication connection between the credential device reader and the controller to a different communications protocol of the communications connection between the controller and the service provider system,

the service provider system processing the received credential data and providing response data to the controller;

where the controller, on receiving the response data, initiates an action and/or conveys the response data to any one or more of the credential device readers, the credential device, a device associated with credential device reader, or a third party device or system.

The controller operates as both a controller & converter for systems, payment, access, or identification, which wirelessly operates within a facility to seamlessly exchange or change data protocols to match existing standards, whilst upgrading the capability of the credential reader device in both security and functionality. Additionally, the controller can simultaneously execute related wireless connected technologies in a network configuration, which enables a camera or other detection device to pan towards the payment or entry point for further validation, biometrics verification or historical video recording.

The credential device reader could have Qi or Qi2 or similar Wireless Power receiver circuit that allows the credential device to power it, thereby enabling Bluetooth or NFC to communicate between the reader and credential. The credential device would have Bluetooth or NFC compatibility with matching encryption algorithm for security applications or smart home.

In an embodiment, a credential card is provided, including:

a BLE and/or IoT IC processing module;

an NFC module;

a Qi wireless power receiver module;

a memory module in communication with the processing module, the memory module storing machine readable instructions executable by the processor module;

a Bluetooth processing module can activate or switch on/off the NFC module to enhance security, reducing the ability to covertly copy NFC information, whilst remaining backward compatible with NFC systems;

a Qi2™ compatible wireless power or electromagnetic induction module for scavenging power from a power source to provide power of approximately five watts or greater to the processing module to execute the machine-readable instructions stored in the memory module, the power source not forming an integral part of the credential card;

a Bluetooth (BLE) or Internet of Things (IoT) module for facilitating communication of data between the credential card and an external electronic data processing and/or reading device;

a Bluetooth, NFC and/or Internet of Things (IoT) module for facilitating multi-device connectivity to enhance security. The Reader is optionally configured to require multiple device detection prior to propagating data or acceptance. The Reader is configured by the Mobile Device App., thus programming the Reader to meet user or operator requirements, which may include upgraded identification and security techniques, such as multiple device detection, multiple technology operation, data collection and dissemination optionally with AI;

a security module for encrypting data being communicated between the credential card and the external electronic data processing and/or reading device; and

an electronic ink screen for displaying user or operator parameters, plus advertiser information, plus logo and health. Additionally, identity and/or biometric data relating to a user of the credential card and/or displaying data relating to a transaction facilitated by the communication of data between the credential card and the external electronic data processing and/or reading device

In an embodiment, a credential card is provided, including:

a processing module;

a memory module in communication with the processing module, the memory module storing machine readable instructions executable by the processor module;

a Qi2™ compatible electromagnetic induction module for scavenging power from a power source to provide power of approximately five watts or greater to the processing module to execute the machine-readable instructions stored in the memory module, the power source not forming an integral part of the credential card;

a Bluetooth module for facilitating communication of data between the credential card and an external electronic data processing and/or reading device;

a security module for encrypting data being communicated between the credential card and the external electronic data processing and/or reading device; and

an electronic ink screen for displaying advertising from third party customers to display one or multiple advertisements associated with the local requirements. Additionally, notices, messages or alerts can be posted or triggered by user or location, based on the local requirements. Advertising information can be static or dynamic, based on local requirements. Advertising, logo, notifications from third parties can allocate sections of the display that are utilized solely for their purpose, therefore segregating certain sections of the display for different operators, users, governments, health organizations, advertisers for any reason or purpose.

An electronic ink screen can be configured or personalized by a mobile device or mobile phone to enable multiple applications in diverse market segments.

The card, reader and controller are configurable by a mobile device to personalize the displayed image, plus application for their specific purposes.

The mobile device has an associated App. that may utilize an Al interface to configure the parameters of the card and/or reader, and/or controller, the physical display and all aspects of operation and communications, including multiple displays or virtual displays. Virtual displays create a multi-card solution within a single physical card.

An electronic ink screen may display user photo image and other details as required by the user or operator. The image and information on the display may have a time frame for operation, which ensures credentials have a built-in lifespan and will delete or change information based on time or location. The ability to update information to the display is a security advantage, and in conjunction with display change could also send warning alerts to operators or service providers when a user validity or payment date has lapsed.

In an embodiment, a credential card is provided, including:

a processing module;

a memory module in communication with the processing module, the memory module storing machine readable instructions executable by the processor module;

a Qi2™ compatible electromagnetic induction module for scavenging power from a power source to provide power of approximately five watts or greater to the processing module to execute the machine-readable instructions stored in the memory module, the power source not forming an integral part of the credential card;

an Internet of Things (IoT) module for facilitating communication of data between the credential card and a first external electronic data processing and/or reading device;

a Bluetooth™ to IoT conversion module for converting data received by the credential card over a Bluetooth connection with a second external electronic data processing and/or reading device, said received data being converted to IoT data for communication from the IoT module to the first external electronic data processing and/or reading device; and

a security module for encrypting data being communicated between the credential card and the first and/or second external electronic data processing and/or reading devices.

A ‘Find My Device’ IC or firmware circuit compatible with Apple, Android, or comparable applications, which combines with Bluetooth to determine location. Pre-assigned or pre-configured operating locations can be used to switch on NFC, BLE, or OTP (One Time Password), based on accepted locations, or monitored from remote locations to assist identification. A combination of ‘Find My’ technology, BLE and IoT long distance communications can work together to determine user or wearer location with far greater effect. Credential reading devices would assist IoT long range operation by extending the operating distance due to their network participation and propagation of the signal data communications, plus triangulation.

Bluetooth switching RF transmissions at 315 MHz, 433.92, and/or 868 MHz operate in various countries with power limitations. Therefore, Bluetooth switching RF propagation in different frequencies at the nominal compliance power output spectrum, creates a global comparable device, which has Bluetooth processing for greater scope, security and flexibility.

In an embodiment, a credential card is provided, including:

a processing module;

a memory module in communication with the processing module, the memory module storing machine readable instructions executable by the processor module;

a Qi2™ compatible electromagnetic induction module for scavenging power from a power source to provide power of approximately five watts or greater to the processing module to execute the machine-readable instructions stored in the memory module, the power source not forming an integral part of the credential card;

a Bluetooth™ module for facilitating communication of data between the credential card and a first external electronic data processing and/or reading device;

an Internet of Things (IoT) to Bluetooth™ conversion module for converting data received by the credential card over an IoT connection with a second external electronic data processing and/or reading device, said received data being converted to Bluetooth™ data for communication from the IoT module to the first external electronic data processing and/or reading device; and

a security module for encrypting data being communicated between the credential card and the first and/or second external electronic data processing and/or reading devices.

In an embodiment, a system is provided, including:

a credential card; and

an external electronic data processing device;

where the credential card includes:

a processing module;

a memory module in communication with the processing module, the memory module storing machine readable instructions executable by the processor module;

a Qi2™ compatible electromagnetic induction module for scavenging power from a power source to provide power of approximately five watts or greater to the processing module to execute the machine-readable instructions stored in the memory module to implement a credential card application, the power source not forming an integral part of the credential card;

an Internet of Things (IoT) module or a Bluetooth™ module for facilitating communication of data between the credential card and the external electronic data processing device;

a security module for encrypting data being communicated between the credential card and the external electronic data processing device;

where the external electronic data processing device is configured, when close enough to the credential card such that the credential card can scavenge energy from the external electronic data processing device, to implement an associated credential card application enabling a user of the external electronic data processing device to communicate data to the credential card to load or confirm one or more of the user's identity data, personal identification number (PIN), biometric data, image data, financial accounts, digital currency, health information, avatar into a non-volatile memory module of the credential card.

In an embodiment, a credential card is provided, including:

a processing module;

a memory module in communication with the processing module, the memory module storing machine readable instructions executable by the processor module;

a Qi2™ compatible electromagnetic induction module for scavenging power from a power source to provide power up to fifteen watts to at least the processing module to execute the machine-readable instructions stored in the memory module, the power source not forming an integral part of the credential card;

a Bluetooth or Internet of Things (IoT) module for facilitating communication of data between the credential card and an external electronic data processing and/or reading device;

a security module for encrypting data being communicated between the credential card and the external electronic data processing and/or reading device; and

an electronic ink screen for displaying identity and/or biometric data relating to a user of the credential card and/or displaying data relating to a transaction facilitated by the communication of data between the credential card and the external electronic data processing and/or reading device.

In an embodiment, a credential card is provided, including:

a processing module;

a memory module in communication with the processing module, the memory module storing machine readable instructions executable by the processor module;

a Qi2™ compatible electromagnetic induction module for scavenging power from a power source to provide power up to fifteen watts to at least the processing module to execute the machine readable instructions stored in the memory module, the power source not forming an integral part of the credential card;

a Bluetooth™ module for facilitating communication of data between the credential card and an external electronic data processing and/or reading device;

a security module for encrypting data being communicated between the credential card and the external electronic data processing and/or reading device; and

an electronic ink screen for displaying identity and/or biometric data relating to a user of the credential card and/or displaying data relating to a transaction facilitated by the communication of data between the credential card and the external electronic data processing and/or reading device.

In an embodiment, a credential card is provided, including:

a processing module;

a memory module in communication with the processing module, the memory module storing machine readable instructions executable by the processor module;

a Qi2™ compatible electromagnetic induction module for scavenging power from a power source to provide power up to fifteen watts to at least the processing module to execute the machine readable instructions stored in the memory module, the power source not forming an integral part of the credential card;

an Internet of Things (IoT) module for facilitating communication of data between the credential card and a first external electronic data processing and/or reading device;

a Bluetooth™ to IoT conversion module for converting data received by the credential card over a Bluetooth connection with a second external electronic data processing and/or reading device, said received data being converted to IoT data for communication from the IoT module to the first external electronic data processing and/or reading device; and

a security module for encrypting data being communicated between the credential card and the first and/or second external electronic data processing and/or reading devices.

In an embodiment, a credential card is provided, including:

a processing module;

a memory module in communication with the processing module, the memory module storing machine readable instructions executable by the processor module;

a Qi2™ compatible electromagnetic induction module for scavenging power from a power source to provide power up to fifteen watts to at least the processing module to execute the machine-readable instructions stored in the memory module, the power source not forming an integral part of the credential card;

a Bluetooth™ module for facilitating communication of data between the credential card and a first external electronic data processing and/or reading device;

an Internet of Things (IoT) to Bluetooth™ conversion module for converting data received by the credential card over an IoT connection with a second external electronic data processing and/or reading device, said received data being converted to Bluetooth™ data for communication from the IoT module to the first external electronic data processing and/or reading device; and

a security module for encrypting data being communicated between the credential card and the first and/or second external electronic data processing and/or reading devices.

In an embodiment, a system is provided, including:

a credential card; and

an external electronic data processing device;

where the credential card includes:

a processing module;

a memory module in communication with the processing module, the memory module storing machine readable instructions executable by the processor module;

a Qi2™ compatible electromagnetic induction module for scavenging power from a power source to provide power up to fifteen watts to at least the processing module to execute the machine readable instructions stored in the memory module to implement a credential card application, the power source not forming an integral part of the credential card;

an Internet of Things (IoT) module or a Bluetooth™ module for facilitating communication of data between the credential card and the external electronic data processing device;

a security module for encrypting data being communicated between the credential card and the external electronic data processing device;

where the external electronic data processing device is configured, when close enough to the credential card such that the credential card can scavenge energy from the external electronic data processing device, to implement an associated credential card application enabling a user of the external electronic data processing device to communicate data to the credential card to load one or more of the user's identity data, personal identification number (PIN), biometric data, image data, avatar into a non-volatile memory module of the credential card. NFC Activation following multi-device detection:

NFC activation in a Bluetooth Card can be switched on or off by the Bluetooth circuit, depending on the conditions preset or desired. One condition is to Bind or Tether the Bluetooth Card to the mobile device or smartphone and thus have the NFC coil switched ON whilst this condition is met. This scenario ensures that both the mobile device and Card are in communication distance before being able to use the NFC coil on existing legacy NFC readers. This scenario ensures that no upgrade is required from the incumbent NFC readers or infrastructure. This scenario creates an enhanced security solution without changing the existing security systems.

NFC with Bluetooth & Find My technology is combined in a card or tag with Qi Wireless Power. Qi Wireless Power or commensurate Wireless Power can be used to charge the internal battery, plus can also be used to operate (power up) the card or tag. Therefore, Qi Wireless power or any equivalent Wireless Power circuit can charge both the battery (if installed) and additionally power the Bluetooth circuit simultaneously.

Existing Access Readers mostly use NFC technology. To upgrade the security of an access system without changing the access readers or system, a combination (multi-device) product is used via communications mediums—Bluetooth BLE Find My, Qi and NFC.

Multiple NFC chips can combine in a Bluetooth Card operated by the user mobile device, selecting the appropriate NFC coil for the task and downloading the information required for successful operation or allowed access. Multiple coils allow many different virtual applications to be downloaded from the phone to the Bluetooth card and combine many applications into a single card. Some examples are Mifare, DesFire, Legic, and NXP etc., all operating at 13.56 MHz, but having a different memory structure and user information. The user information can be stored on the user or proprietor mobile device and downloaded as required or as selected by the user. This solution enhances security, can turn on or off the NFC and can select from multiple NFC chips that are installed in the Bluetooth Card. Bluetooth communications plays a major role in the security and convenience of multiple NFC chips operating in a single physical Card.

Users or Operators can determine the location and last location of the card or tag through Find My network. The Find My network can be used by the Operator for work purposes, or by the User for personal purposes.

Several different forms are available:

Card or Tag powered by Qi and used with the initializing device only. The User can detach the card or tag and stop the location determination.

Card or Tag with battery and therefore detectable by the initialization device through the Find My network.

Card or Tag with different formats of NFC, 125 KHz, 13.56 MHz, NFC switchable on and off by the Bluetooth detection of the mobile device.

Parameters of operation are initialized by the mobile device of the Operator or the User.

The above assures the access requirements are first met using both the mobile device of the user and the Card or Tag issued. The Card or Tag issued has the Bluetooth Find My capability and an NFC switchable technology for all types of NFC.

Octopus transport operators in Hong Kong issue a Bluetooth or Bluetooth+Find My Card or tag to be used on their transportation readers or with their many merchants. A floor limit can be applied, where minimum payments require multi-device detection. Multi-device detection is the ability of Bluetooth in the Card or Tag to determine the ‘in-range’ initializing or designated mobile device, before switching ON.

The multi-device system ensures both the mobile device designated for the User and the Card or Tag are together at the point of purchase. If the initializing or designated mobile device is not ‘in-range’ of the Card or tag, the purchase can only be made up to a floor limit. When the initializing or designated mobile device is ‘in-range’, the NFC is ON, and the floor limit is raised or is deemed fully operational for any payment amount. When used in access control situations, the mobile device must accompany the Card or Tag before the NFC is switched ON.

If the mobile device is lost or stolen or changed, the Operator or User must satisfy amendment queries locally or remotely on the Card or Tag via the new mobile device.

When dialing in or accessing network or computer system, using the combination of User's mobile device and Bluetooth Find My Card or Tag upgrades identification determination through multi-device combination, based on the comparison techniques of actual location compared to the User's known operating location. The existing process of accessing network or computer system is same for the User, as he only needs his normal mobile device ‘in-range’ of the Bluetooth Find My Card or Tag, the User is oblivious to the extra security.

In an embodiment, an E-INK Reader display and access control system is provided, including:

a Bluetooth Reader operating from the inside (secure side) of the access point.

an outside doorbell, buzzer, microphone, camera, speaker, operated from the inside Reader by Bluetooth.

Push button and camera image is taken and transmitted to Reader.

Local or remote access can be initiated from owner's mobile device.

Outside doorbell asks for person's name, this voice image is compared to database entry at the memory location of the Bluetooth ID, and compared biometrically, one to one.

The outside doorbell takes user image and transmits to the inside Reader, biometrically comparing to database entry at the Bluetooth memory location, one to one.

Biometrics and Bluetooth comparison at memory location is fast and more reliable, one to one. Two factor identification is also achieved if the doorbell user personal device ID or access card ID is used in the entry criteria.

Installing non-Battery devices on walls, equipment, and devices:

Reversing the traditional concept of placing ‘powered devices’ on walls for access, payments, display terminals and equipment can be accomplished by using non-battery/non-powered devices.

A significant advantage is the wall reader is simple, inexpensive and extremely think, therefore aesthetically pleasing. The non-powered reader doesn't require wiring power, batteries or any operational power source. The non-powered reader could be placed on glass, either on the outside of the glass door/window, or on the inside, as BLE, NFC and Qi Wireless Power will operate over distances approximately 4 inches or more.

In this situation, the user carries the powering device with the access device. Typically, mobile phones have Qi or Qi Wireless output capability for powering wearables etc. Therefore, the user badged their mobile device or power source, and Bluetooth (BLE) becomes activated, plus any other integrated technologies, such as NFC, IoT etc. Once the wall reader is activated by the user power source, it communicates to a connected device, which may be local or remote and could be standalone operated or controlled from a central computer system, cloud based or AI combination for the purposes of ensuring the correct user identification.

The E-INK display is also powered by the user power source and can be activated to use voice prompts, or speaker/buzzer output to indicate information to the user. Bluetooth (BLE) can immediately activate a switch BLE circuit to open the door or access solenoid for entry, alternatively it could connect to larger database controller and integrate AI parameters prior to allowed entry, this introduces greater centralized control potential for a larger organization of higher security situation.

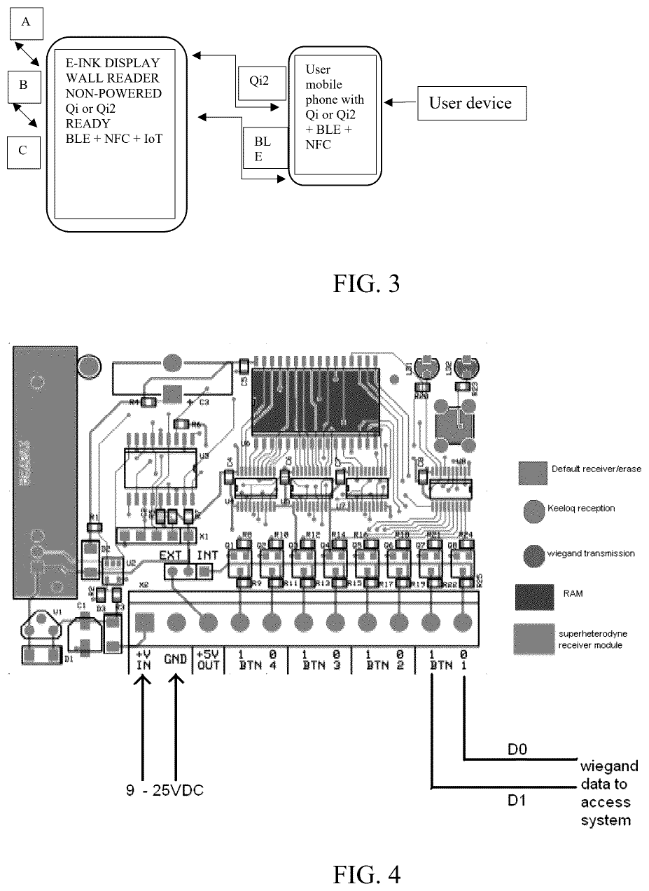

In FIG. 3, the user brings the power source together with the communicating medium. Once the non-powered wall reader is powered by the user device, the circuit is enabled, and the user device ID is determined and transmitted either locally or remotely.

FIG. 3 shows three reader output scenarios (A, B, C):

A: could be a BLE receiver with Wi-Fi or data connectivity to transmit the user device ID to a computer system that controls multiple devices and holds the user database and access rights. AI would prove valuable in such a situation as the AI could determine location, ID, User ID and determine if there are multiple user IDs in operation globally.

B: could be a BLE switch connected to the entry point to immediately open the door or access point once a valid encryption key and ID are ascertained. This scenario is for localized control where the non-powered wall reader would need to be configured with allowed ID's, time slots, etc.—a manual process.

C: could be a local computer system operated by the homeowner or business operator and integrate other IoT devices, such as cameras, lights, theft detection software, plus location and movement tracking, perhaps integrating AI for a broader real-time and more comprehensive determination of security/access rights and identification.

The same system identified in FIG. 3 could be adapted to store labelling or pricing, with E-INK displays being modified by the user mobile device, upon bringing the user device to a position that allows Qi, BLE and NFC to operate and function. The non-powered E-INK display will remain as programmed by the user device without further requirement for power to operate. E-INK displays only require power to change, not to remain visible thereafter.

The system in FIG. 3 can be adapted to many industrial requirements where battery or powered devices are cumbersome or involve maintenance and upkeep. Additionally, sending battery powered devices by airfreight or mail is becoming increasingly costly. Therefore, removing the self-powering requirement for the reading device is significantly advantageous. The user can actually bring the required power source with the identification device, mobile phone, or any devices with Qi or commensurate wireless power output capability. Typically, mobile phones will have Qi or Qi2 available for powering wearables etc.

The system in FIG. 3 can propagate the BLE or NFC signal into long range IoT for connection to more distant computers or controllers. The power source can easily power the E-INK display changes, plus BLE and IoT—all of which operate with minimal power requirements. Most Qi or Qi2 power output is 15 W and more, the E-INK display and BLE or IoT will probably only require around 5 W wireless power for approx. 2 seconds.

Implementing E-INK displays with Wireless Power—replacing battery power:

Implementing E-INK displays is common with battery power; however, batteries are not always convenient, and it is sometimes preferable to use non-Battery products. Wireless Power is becoming more capable and with greater use cases, which will continue as applications are expanded.

Integrating Wireless Power circuits within E-INK displays is optional to enabling a power source, which is removable and rechargeable.

Qi2 or similar Wireless Power circuits are growing in popularity and being added to mobile phones for recharging wearables (earplugs etc.). Therefore, it is a prominent depiction in these descriptions that mobile phones can act as the power source. Additionally, the communication medium, plus the mobile App becomes the display setup with some flexibility for adding the security encryption data keys for single or broad user operations and configuration of the E-INK display operational parameters.

Utilizing Bluetooth devices and wearables to supplement Find My technology:

Bluetooth devices can have a non-secure ID or sector of memory that is available for third party uses. This is significant when we consider the proliferation of Bluetooth Wearables and IoT longer range RF systems installed around the world today.

This description will define the operational aspects of using Find My technology backbones from Apple and/or Android, combining with Bluetooth and IoT devices that conform to a manner of advertising (pinging) their ID in open source and for the accumulation of data around the globe without being reliant on Data or Wi-Fi networks.

Bluetooth and IoT devices will be installed on walls, in wallets, on pets, animals, humans, luggage, valuables and for a variety of purposes. Expanding the Find My network through a CLOUD BASED AI Platform allows for the accumulation of data from propagating devices or IoT Advertising (ID broadcasting) devices into an accumulation packaging and deciphering AI system, which determines many parameters of location, usages, ownership, and many other statistics. The abilities are for this AI system to completely negate or ameliorate the requirements from Data or Wi-Fi networks.

Every Bluetooth and IoT devices advertise their ID, which can be collected by any other Bluetooth device and the location is determined from one source or another. All the information is fed back to the AI Platform for data accumulation and determination.

The AI Platform is quite capable of drawing conclusions from the IoT/Bluetooth ID pings in relation to other pings received, within or outside the vicinity of each ping. It may be possible to add pings from mobile towers or other RF/IoT propagating equipment.

The accumulation of ID data can assist in location services, to fine-tune location or operate in the absence of Data or Wi-Fi networks. The installation base of cards is around 50,000,000,000 and includes the largest technology usage by volume in human history. Therefore, migrating these cards to a Bluetooth/IoT solution allows for significant ID accumulation and a Bluetooth/IoT network of substantial capability, without the need for Data or Wi-Fi networks.

Data can propagate on these backbone Bluetooth/IoT networks with ease and be accumulated in an AI platform with some clarity of usage characteristics, location and for identification purposes. The security aspects are available to quickly monitor for card cloning and misuse. The characteristics of location and personal application can be determined and cross-checked for identity and other purposes.

Accumulating Bluetooth and IoT ID's is accomplished by network access to the AI Platform, this could be through the associated mobile phone App., other Wi-Fi or data networks. The accumulation of data from many sources allows determinations to be considered, taking into account the movement from location to location, speed of transit, distance travelled in a given time frame. Conversely, immobilization can be determined as some incapacity or sleep.

NFC hardware can be replicated by firmware inside a Bluetooth processor, enhancing security, encryption and flexibility. NFC emulation is simply embedded into the Bluetooth processor and separate 13.56 MHz antenna or multiple antennas of any frequency connected for optimum NFC operating range.

The advantages of the above scenario offer several benefits, as below;

Lower cost of card/tag.

More secure.

More adaptable, flexible connectivity.

Upgradeable online firmware revisions etc.

Longer NFC operating range because the antenna is more efficient.

Integration of multiple applications on Bluetooth processor.

Ability to communicate with any mobile device App.

Ability to combine many NFC firmware configurations for multiple-virtual cards.

Battery or battery less operation when Qi2 Wireless Powered.

Easy and cheap to upgrade existing NFC readers. Simply add Qi Wireless charge coil for normal operation of the NFC firmware embedded inside Bluetooth processor.

Additional hardware options include speaker for buzzer function, microphone for voice activation, microphone/camera for biometrics.

E-INK display can change depending on the multiple virtual card selection by the user.

Touchscreen on top of E-INK display.

Mobile device App. user selections via Bluetooth communication connection.

Multiple applications can include Find My functions, wearable connectivity, buzzer attention or confirmation sounds, LED display for RED/GREEN, GO/NOGO actions.

E-INK display optionally changed from mobile device selections by the user. Mobile devices with Qi Wireless Power, simultaneously providing power and communications.

E-INK display automatically activated when used in payments/access/identification scenarios.

E-INK display requires no further power after display change has been performed.

Advertising options for the user on mobile device App., or on the E-INK display of the multiple virtual cards.

Alert messages for the user on the mobile device of multiple virtual cards.

Possible fingerprint module integration or any technology consistent with the safer, more secure operation of a multiple virtual card.

In an embodiment, a multiple virtual card with AI operating system is provided.

In an embodiment, a Qi Wireless Powered credential or card with Bluetooth processor, NFC and IoT, plus E-INK or comparable display, with extra storage and optionally attached to the rear of mobile devices is provided.

The above hardware combination and an AI operating system of platform gives an enormous allowance of multiple secure applications. AI can be used in a credential that is powered by Qi or contains battery charged by Qi and includes display that is available on the rear of the mobile device or Standalone on desktops, walls, glass doors etc. Because there is reduced requirements for powering by traditional methods, prior to Qi widespread availability.

AI can be sued to identify files on the Bluetooth credential, as required by the user. The user simply asks the resident AI platform to select images, documents, passwords, information requested, or optionally giving multiple information for further selection refinement.

AI works with the user to monitor and access information from the credential, which remains using the same file system as designed today, therefore no change to the manner of file maintenance, AI simply operates on top of the existing file system and is able to select, determine, decide, hint or remind the user of stored information.

Additionally, AI can determine information from external sensors and control external sensors by communication of Bluetooth, NFC or protocol conversion to IoT, SMS, Wi-Fi or other methods. The user could select room operating temperature and AI will turn on or off, air conditioning to meet the user requirements or selections.

Having a display medium allows visual feedback to the user and touch screen for additional inputs, plus the ability to select screen displays and thereby enable multiple virtual display credentials for banking, cash cards, access, identification and health certificates etc.

The AI controlled credential can also be accessed by traditional means, generally by Bluetooth or NFC, but will contain many communication options.

The memory will generally be in terabytes to accommodate large files and the AI operating platform. Fingerprint or biometrics will generally be required in the associated mobile phone App., but may be added to the credential in certain applications. Voice control, camera imaging, microphone will all be optionally available in the credential. Protocol conversion will take place seamlessly and automatically with the AI platform, which can determine the communication protocol of each controllable external device output, or input.

External devices can be automatically scanned and determined by AI platform, allowing the user to select their requirements with ease.

External monitoring of environmental conditions, air quality, radiation, pollen, airborne or prevalent viruses, which can be scanned by hardware sensors in the credential. AI will take these inputs and give information in the required human format and with alerts, suggestions, advices etc.

First information is a time-sensitive alert or an advertisement.

AI protocol conversion for incoming and outgoing messages is a significant advantage that takes the user mobile device to enormous additional operating parameters, whereas it is limited to Bluetooth, NFC, data or Wi-Fi networks today. The mobile phone utilizes the credential for a variety of purposes and accesses its own processor and memory, plus its own AI for other applications and in coordination with the credential AI, monitoring passwords, bank account information sharing, unknown account usages etc. The mobile phone App. Attached the mobile phone system to the credential AI platform and ensures secure communication from credential and mobile phone, once the user-ID of each is connected by the user or operators.

Online advertising with the front mobile device display or the rear credential display can be accomplished by retailers messaging as proximity-based information nearby sales, urgent attention to public safety etc.

The mobile phone App allows the credential AI system to be upgraded, modified or enhanced for every perceived application and for multiple coincidental applications.

The AI credential platform will optionally have an embedded or cloud-based control center for broader security, location and identity confirmation. Various sophisticated encryption techniques will be utilized to ensure the secure operation of AI credential and mobile device App. are not compromised.

External communications and sensors are endless and increasing as new protocols and actions are invented or enhanced. Internal communications can utilize the same sensors for dissemination.

Cameras can be used to scan an environment, a transaction or images for user assured of authenticity. Security cameras can be controlled by the credential in pan/tilt/zoom, plus AI determination and possible alerts of any breaches, changes etc.

The AI credential is a mobile device adjunct card with enormous value and reach, making the user mobile phone much more capable whilst reducing the instances of fraud, atta KS, phasing etc. AI will be able to determine many attack scenarios before they are carried out.

The apparatus described above may be implemented at least in part in software. Those skilled in the art will appreciate that the apparatus described above may be implemented at least in part using general purpose computer equipment or using bespoke equipment.

Government issued driving licenses, passports, health certificates would all benefit from incorporating the credential card multi-purpose technologies and having variation of style and shape.

Transposing the credential card into a credential reader offers the ability to momentarily/manually power the credential card and thereby negating/removing the traditional power source entirely. Placing this transposed credential card on the inside of glass doors is possible and a typical example of its uniqueness, whereas the credential card can be powered through glass or non-metallic material, or directly, by wireless charging devices. The credential card simultaneously decodes the Bluetooth signal for entry access, identification, protocol change, location determination or display change, conducting the desired operation whilst wireless power is supplied. A credential card without battery has many advantages that minimize power exhaustion from batteries, explosions or fires, replacement management and remove wiring connections, reduce costs and offers ISO card size options.

The credential card can also be configured to switch NFC based on BLE communications, thereby using Bluetooth BLE as the overarching communications protocol and switching or controlling the NFC circuit or multiple NFC circuits. NFC circuits effectively become a subset of the Bluetooth circuit or primary communications platform. The Bluetooth circuit can select the appropriate NFC circuit for any application or requirement. The Bluetooth circuit can hold the configuration of the NFC circuit and apply the appropriate configuration based on the requirement, thereby minimizing NFC hardware circuits and maintaining multiple virtual NFC configurations in a single Bluetooth circuit. Credential card operation can be enhanced by identifying location via Bluetooth technology, prior to activating the NFC technology, plus many other parameters available to Bluetooth but not necessarily NFC capable. The remote issuance, delivery, and activation of the credential card can be conducted securely without human intervention by Bluetooth circuits, over Wi-Fi, data or wireless networks, incorporating the NFC configuration.

Remote or local access or login services would be enhanced by using at least one of biometrics, location, or multi-device detection.

An AI embedded or cloud-based system assists by identifying and managing the complexities of multiple protocol conversions that are inherent in different devices from various manufacturers. Environmental recognition assists controllability with an embedded AI or cloud-based system, designed to meet the requirements of connecting multipolar technology devices. AI supports security by determining the environment and individual devices requiring access or activation. AI has multiple external inputs available for identification of the user and can be configured to restrict access, activation or transposing of protocols until authentication of the user. AI can assist remote or local access by user identification, based on environment and related devices identification. A wireless communications environment enables the connection of many varied devices, protocols and users, simultaneously.

The additional functions of the credential device reader enhance security without modifying the existing interface of the service provider. A communications link between the controller and the service provider system typically uses a Transmission Control Protocol/Internet Protocol (TCP/IP), however this is more generally conducted by wireless protocol transmission systems.

The credential device could operate without battery and use wireless charging as the primary input power. The option to power the credential device from wireless power source could be assisted by supercapacitors that store energy in a very efficient and long-life manner.

The display medium enables multiple virtual card configurations, combining multiple card applications within a single physical Bluetooth circuit plus display, which also informs the user of the specific application pending. The application can be automated based on a device request, specific environment, or user selected.

The credential card is a figurine, badge, boarding pass, or ornament style device, embedding the same technologies as the card, but offering a unique shape, style or functionality. The credential card or figurine can be carried, displayed or worn as an ID, enabling corporate, retail or industrial tracking, possibly with analysis of movement. Airports, hospitals, industrial facilities, corporate premises, conference visitor ID's, could monitor movement for security, marketing analysis and layout for environment enhancement, creating efficiencies and understanding behavior. Workers, cleaners, contractors, third party services with ID badges are monitored, both for location and badge expiry, possibly also historical movement. Government issued driving licenses, passports, health certificates would all benefit from incorporating the credential card multi-purpose technologies and having variation of style and shape. The credential card or figurine may also include a display medium, LED lighting, wireless recharge and multiple technologies, NFC, IoT, BLE etc.

The credential card is an environment detection device, designed with sensors that determine air quality or potential hazards: pollution, pollen, air or physical anomalies of any kind. The application of the credential card as an environment sensor detection device utilizes the same technologies of the credential card; wireless power source, Bluetooth communications, display medium and optional battery.

The credential card conducts and stores blockchain actions, which can be updated through several stages, and by several update methods typically using Bluetooth communications, an E-INK display, wireless power, with or without battery. Combining time of update, location and other inputs, the blockchain system will prove the status or origin of food production, plus authenticity and determine food quality or health, based on the updated input stages from inception, refined, determined, and authenticated through blockchain techniques. Blockchain techniques integrated with the credential card can be applied to manufacturing processes and materials, and providence in any field.

The credential card includes an AI (Artificial Intelligence) system internally or cloud based. The AI system assists the protocol conversions, data dissemination that includes at least one of, location, user history (blockchain), in-range devices that combine for multi-device security, number of ID's or cards being used (identifying copy cards) and other facets of operational determinations for security or identification in an offline or real-time basis.

The credential card is used in a location finding scenario, such as Apple and Android Find My devices, which can grab or decipher the device name from the App, as edited by the owner or the original naming convention from the manufacturer, and apply the name or data string to the credential card display. The credential card can replicate, copy and paste the Find My name or data string with a visual representation, same or similar to the App. original or edited name or data string. Typically, the display would be like an E-INK technology, where the display can last for years without further input power, after visual display change. Display change requires power only for the period required to change the display, fully or partially. Power or charging methods include using rechargeable battery or no battery, accessing a wireless power source, battery pack, or an associated device etc. Simultaneously, a Bluetooth or any wireless communication signal determines the new display information.

Here, aspects of the methods and apparatuses described herein can be executed on any apparatus including the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

While the present disclosure has been illustrated and described in detail in the drawings and foregoing description, the same is to be considered as illustrative and not restrictive in character, it being understood that only exemplary embodiments have been shown and described and do not limit the scope of the present disclosure in any manner. It can be appreciated that any of the features described herein may be used with any embodiment. The illustrative embodiments are not exclusive of each other or of other embodiments not recited herein. Accordingly, the present disclosure also provides embodiments that include combinations of one or more of the illustrative embodiments described above. Modifications and variations of the present disclosure as herein set forth can be made without departing from the spirit and scope thereof, and, therefore, only such limitations should be imposed as are indicated by the appended claims.

In the claims which follow and in the preceding description of the present disclosure, except where the context requires otherwise due to express language or necessary implication, the word “include” or variations such as “includes” or “including” is used in an inclusive sense, i.e., to specify the presence of the stated features but not to preclude the presence or addition of further features in various embodiments of the present disclosure.

It is to be understood that, if any prior art publication is referred to herein, such reference does not constitute an admission that the publication forms a part of the common general knowledge in the art.

What is claimed is:

1. A system, comprising:
a credential device, configured to receive power via wireless charge or magnetic induction;
a credential device reader, configured to wirelessly provide power to the credential device using a charging standard; wherein, a Bluetooth signal is able to bi-directionally communicate with the credential device via a first protocol;
a controller, connected to the credential device reader and configured to convert credential data received from a wireless protocol to a second protocol
wherein the controller is configured to convert the second protocol to the wireless protocol and transmit the wireless protocol to at least one of the credential device reader, the credential device, or a third-party device.

2. The system according to claim 1, wherein the credential device reader comprises at least one of: a camera, an E-INK display, a USB input connection, a recharging battery pack, a wireless power source, or a biometric data input means;
the credential device reader comprises a battery or a power source and is configured to charge the credential device via the charging standard, wherein the charging standard is a wireless charging standard or a wired charging standard;
the wireless charging standard comprises at least one of: a Qi standard, a MagSafe standard, a Power Matters Alliance (PMA) standard, an Alliance for Wireless Power (A4WP), a Super Charge Protocol (SCP), or a HyperCharge standard;
the credential device comprises an ISO or non-ISO card-sized device with a Near Field Communication (NFC) functionality; and
the first protocol comprises at least one of: a Bluetooth Low Energy (BLE) protocol, NFC, an Internet of Things (IoT) protocol, message queuing telemetry transport (MQTT) protocol, a constrained application protocol, a long range wide area network protocol, or a Zigbee protocol, and the second protocol comprises at least one of: a Wiegand-compatible clear-text protocol, a unidirectional clear-text protocol, an industrial serial communication standard, or a manufacturer-specific unidirectional clear-text protocol.

3. The system according to claim 1, wherein the controller, the credential device reader or the credential device comprises:
an artificial intelligence (AI) system, configured to assist the protocol conversion with environment recognition, based on database of devices being activated, controlled or switched.

4. A system comprising:
a credential device, configured to receive power via wireless charge or magnetic induction from a credential device reader or an associated device comprising at least one of a mobile phone or a battery pack; wherein the credential device reader is configured to wirelessly communicate with the credential device using a first protocol; and
a controller wirelessly, connected to the credential device reader and configured to convert credential data from a wireless protocol to a protocol compatible with a service provider system;
wherein the service provider system is configured to process the credential data and transmit response data to the controller;
wherein the controller initiates an action or transmits the response data to at least one of the credential device reader, the credential device, or a third-party device.

5. The system according to claim 4, wherein the credential device reader administrates an additional action to determine authenticity, identity or validity of the credential device, wherein the additional action comprises at least one of multi-device detection, biometrics detection, location, time or an input; in response to that a required condition is met within the credential device reader, a communications link is opened, and a protocol or transmission parameter is sent.

6. The system according to claim 4, wherein the credential device comprises a rechargeable battery charged via a charging standard, and the charging standard is a wireless charging standard or a wired charging standard.

7. The system according to claim 4, wherein the credential device is paired with an associated device, and the associated device provides power to the credential device via wireless charge or magnetic induction, or
the credential device reader comprises a super capacitor for immediate power delivery to the credential device; and the super capacitor is further used as a primary supporting power source, in a case that no battery is present.

8. A credential card, comprising:
a processor;
a memory storing machine-readable instructions executable by the processor;
a Qi2-compatible or a wireless power circuit or an electromagnetic induction module, configured to scavenge power from an external source to provide power to the processor;
a wireless communication module, configured to support at least one of Bluetooth Low Energy (BLE), Near Field Communication (NFC), or Internet of Things (IoT) protocols; and
a security module, configured to encrypt data transmitted via wireless communication.

9. The credential card according to claim 8, further comprising a display medium, configured to display at least one of user identity data, biometric data, or transaction-related information.

10. The credential card according to claim 8, further comprising a supercapacitor for short-term power storage and immediate power delivery to the circuit or processor.

11. The credential card according to claim 8, wherein the wireless communication module comprises both BLE and NFC functionality, and the credential card is configured to cross-validate unique identifiers from both BLE and NFC protocols.

12. The credential card according to claim 8, further comprising a biometric sensor configured to authenticate a user before enabling data transmission.

13. The credential card according to claim 8, further comprising an E-INK display, wherein the E-INK display is dynamically updatable via the wireless communication module to show first information, and the first information is capable of being activated by at least one of location, time, promotions or proximity to initiating services;
the security module implements one-time password (OTP) generation using a unique identifier of the credential card; and
the credential card further comprises a protocol conversion module configured to convert data between Bluetooth, BLE and a secondary protocol comprising at least one of IoT, IR, NFC, serial communications, USB or any secondary protocol requirements; and
the credential card further comprises a temperature sensor or health determining sensor integrated with the circuit or processor.

14. The credential card according to claim 8, which is a figurine, badge, boarding pass, or an ornament style device.

15. The credential card according to claim 8, provided with a display, configured to operate as a store or retail display, product or price labelling, office nameplate, placard, signage, or wall hanging.

16. The credential card according to claim 13, configured to operate as a wall mounted card reader.

17. The credential card according to claim 13, which is an environment detection device, provided with a sensor that determines air quality or potential hazards.

18. The credential card according to claim 13, configured to conduct and store blockchain actions, which are capable of being updated through several stages, and by several update methods.

19. The credential card according to claim 13, comprising an artificial intelligence (AI) system internally or cloud based, wherein the AI system is configured to assist protocol conversion and data dissemination that comprises at least one of, location, user history, in-range devices that combine for multi-device security, number of ID's or cards being used.

20. The credential card according to claim 13, used in a location finding scenario, comprising Apple and Android Find My devices.
